(19) United States
(12) Patent Application Publication
(10) Pub. No.: US 2026/0161117 A1
(43) Pub. Date: Jun. 11, 2026

(54) IMAGE FORMING APPARATUS

(71) Applicant: CANON KABUSHIKI KAISHA, Tokyo (JP)

(72) Inventor: TOMOKO FUKUMIZU, Ibaraki (JP)

(21) Appl. No.: 19/183,247

(22) Filed: Apr. 18, 2025

(30) Foreign Application Priority Data
Apr. 19, 2024 (JP) 2024-068719

(51) Int. Cl. G03G 15/16; G03G 15/00

(52) U.S. Cl. CPC G03G 15/1605; G03G 15/1695; G03G 15/5004; G03G 15/5029; G03G 15/6558; G03G 2215/00409

(57) ABSTRACT

An image forming apparatus includes an image bearing member, an intermediary transfer member, a transfer belt for forming a transfer portion, a first applying portion for applying a transfer bias, a first member, a second member for forming a charging portion between itself and the first member, a second applying portion for applying a charging bias, a detecting portion for detecting a current or a voltage, and a controller. The controller sets the transfer bias when a toner image is transferred onto a recording material of which transfer surface is charged to the opposite polarity to a normal charge polarity of toner in a charging portion, on the basis of a detection result by the detecting portion when a region of the transfer belt passed through the charging portion when the charging bias is applied to the charging portion passes through the transfer portion immediately thereafter.

### FIELD OF THE INVENTION AND RELATED ART

The present invention relates to an image forming apparatus, such as a copying machine, a printer, a plotter, a facsimile machine, or a multi-function machine having a plurality of functions of these machines, using an electrophotographic type or an electrostatic recording type.

Conventionally, in the image forming apparatus such as the copying machine using the electrophotographic type, a toner image is electrostatically transferred from an image bearing member such as the photosensitive member or an intermediary transfer member onto a recording material such as paper. Transfer is performed in many cases by forming a transfer portion by contact of a transfer member such as a transfer roller with the image bearing member and then by applying a transfer bias to the transfer portion. Further, for example, in a high-speed machine or the like, a belt-type transfer member for conveying a recording material to the transfer portion by a belt stretched by a plurality of rollers including the transfer roller has also been known.

In such an image forming apparatus, when a transfer current supplied to the transfer portion by the transfer bias is insufficient, an image defect, such as “transfer void” or “poor density”, by which the transfer is not sufficiently performed by thus a desired image density cannot be obtained occurs in some instances. Further, when the transfer current supplied to the transfer portion by the transfer bias is excessive, electrical discharge occurs in the transfer portion, and by the influence of the electric discharge, a polarity of an electric charge of toner is reversed or the like, so that an image defect such as “white void” such that the toner is not partially transferred occurs in some instances. For that reason, in order to form a high-quality image, it is required that an appropriate transfer bias is applied to the transfer portion.

Therefore, there is a method in which a setting of a voltage value of a transfer bias by acquiring a voltage-current characteristic under application of a test bias to a transfer portion in a state in which the recording material is absent in the transfer portion to acquire a voltage value at which a predetermined target current is obtained and then by adding, to this voltage value, a recording material part voltage depending on a kind of the recording material, is made.

However, as the recording material, in some cases, a high-resistance recording material such as synthetic paper higher in volume resistivity than plain paper and coated paper is used. Further, in the case where such a high-resistance recording material is used, shortage of a high voltage (shortage of transfer current) in the transfer portion becomes a problem.

Japanese Laid-Open Patent Application (JP-A) 2013-171282, it is proposed that a surface of a recording material onto which a toner image is transferred (“toner image transfer surface”) is electrically charged to an opposite polarity to a normal charge polarity of toner in advance (“pre-charging”) before the recording material reaches a secondary transfer portion. Particularly, in JP-A 2013-171282, in a constitution using the belt-type transfer member, the pre-charging is performed on a belt provided upstream of the transfer portion.

In the constitution in which the belt-type transfer member is used and in which the pre-charging is performed on the belt, a potential of the belt is fluctuated by output of the pre-charging, so that it becomes hard to apply an appropriate transfer bias in the transfer portion in some cases.

### SUMMARY OF THE INVENTION

A principal object of the present invention is to appropriately set the transfer bias in the constitution in which the belt-type transfer member is used and in which the pre-charging is performed on the belt.

This object is accomplished by an image forming apparatus according to the present invention.

According to an aspect of the present invention, there is provided an image forming apparatus comprising: an image bearing member configured to bear a toner image; an intermediary transfer member onto which the toner image borne on the image bearing member is transferred; a rotatable transfer belt constituted by an endless belt and configured to form a transfer portion in contact with the intermediary transfer member, the transfer belt conveying a recording material toward the transfer portion while carrying the recording material; a first applying portion configured to apply, to the transfer portion, a transfer bias for transferring the toner image from the intermediary transfer member onto the recording material; a first member provided on an inner peripheral surface side of the transfer belt and on a side upstream of the transfer portion with respect to a recording material conveying direction and configured to form a charging portion where a transfer surface which is a surface of the recording material onto which the toner image is transferred and which is conveyed to the transfer portion by the transfer belt is electrically charged to an opposite polarity to a normal charge polarity of toner; a second member provided on an outer peripheral surface side of the transfer belt and configured to form the charging portion while sandwiching the transfer belt between itself and the first member; a second applying portion configured to apply, to the charging portion, a charging bias for charging the transfer surface of the recording material to the opposite polarity; a detecting portion configured to detect a current flowing through the transfer portion or a voltage applied to the transfer portion; and a controller configured to set the transfer bias on the basis of a detection result by the detecting portion, wherein the controller sets the transfer bias when the toner image is transferred onto the recording material of which transfer surface is charged to the opposite polarity in the charging portion, on the basis of a detection result by the detecting portion when a region of the transfer belt passed through the charging portion when the charging bias is applied to the charging portion passes through the transfer portion immediately thereafter.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of an image forming portion.

FIG. 3 is a black diagram showing an outline of a control constitution of the image forming apparatus.

FIG. 4 is a schematic sectional view showing a structure of a neighborhood of a secondary transfer portion, showing an example of a voltage applying constitution.

FIG. 5 is a flowchart showing an outline of procedure of ATVC.

FIG. 6 is a graph showing a voltage-current characteristic acquired in the ATVC.

FIG. 7 is a schematic view showing an example of a table of a recording material part voltage.

FIG. 8 is a flowchart showing an outline of procedure of control in an embodiment 1.

FIG. 9A is a flowchart showing an outline of procedure of control in an embodiment 2.

FIG. 9B is a flowchart showing outline of procedure of the control in the embodiment 2.

FIG. 10A is a flowchart showing an outline of procedure of control in an embodiment 3.

FIG. 10B is a flowchart showing an outline of procedure of the control in the embodiment 3.

FIG. 11 is a graph showing a voltage-current characteristic acquired in a pre-multi-rotation step in the embodiment 3.

FIG. 12A is a flowchart showing an outline of procedure of control in an embodiment 4.

FIG. 12B is a flowchart showing an outline of procedure of the control in the embodiment 4.

FIG. 13 is an illustration showing a control timing in the embodiment 4.

FIG. 14 is a schematic sectional view of a neighborhood of a secondary transfer portion, showing another example of the voltage applying constitution.

### DESCRIPTION OF EMBODIMENTS

In the following, an image forming apparatus according to the present invention will be specifically described with reference to the drawings.

### Embodiment 1

### 1. Constitution and Operation of Image Forming Apparatus

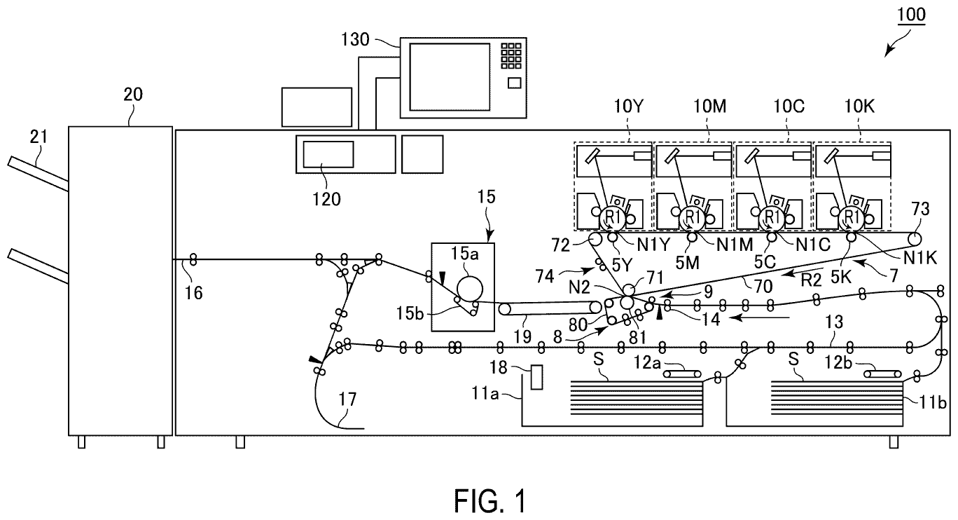

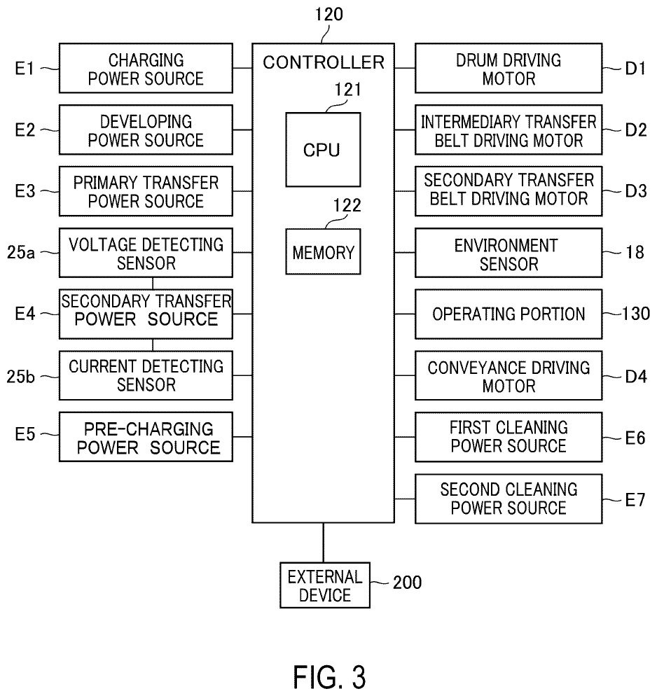

FIG. 1 is a schematic sectional view of an image forming apparatus 100 of an embodiment 1. The image forming apparatus 100 in this embodiment is a tandem full-color printer which is capable of forming a full-color image with use of an electrophotographic type and which employs an intermediary transfer type. The image forming apparatus 100 is capable of forming and outputting an image on a sheet-like recording material on the basis of image information inputted from an external device 200 (FIG. 3) or image information inputted through an operating portion 130 (or image reading apparatus) provided to the image forming apparatus 100, or the like. As the external device 200, it is possible to cite a host device such as a personal computer, or digital camera, a smartphone, for example.

Incidentally, in the image forming apparatus 100, paper is principally used as a recording material, and therefore, the recording material S is referred to as paper in some instances, but the recording material S is not limited to the paper. The recording material S may only be required to be a recording material on which a toner image can be formed, and as a specific example thereof, it is possible to cite plain paper, a sheet made of a synthetic resin which is a substitute for the plain paper, thick paper, a sheet for an overhead projector. Thus, as the recording material S, for example, it is also possible to use, for example, recording materials constituted by materials other than paper or materials containing the materials other than the paper, such as a synthetic paper or a film constituted by a material principally comprising a synthetic resin, and special paper such as metallized paper having a metal layer, and the like.

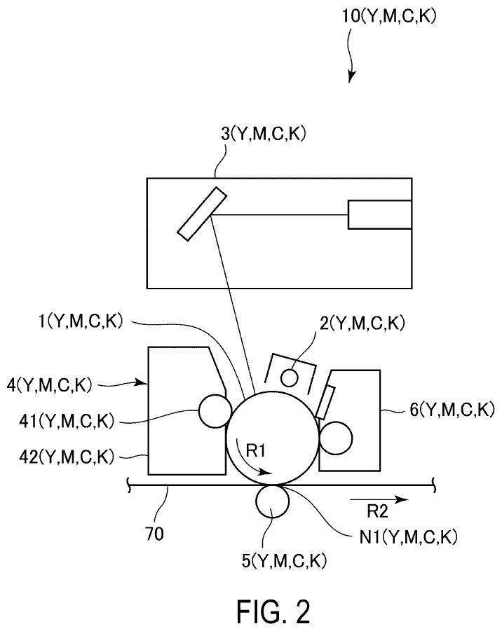

The image forming apparatus 100 includes four image forming portions 10Y, 10M, 10C and 10K for forming color images of yellow (Y), magenta (M), cyan (C) and black (K). The respective image forming portions 10Y, 10M, 10C, and 10K are linearly arranged along a movement direction of an image transfer surface of an intermediary transfer belt 70 provided substantially horizontally as described later. Incidentally, as regards elements provided for respective colors, and having the same or corresponding functions or constitutions, suffixes Y, M, C and K for representing the elements for associated colors are omitted, and the elements will be collectively described in some instances. In this embodiment, the image forming portion 10 is constituted by including a photosensitive drum 1, a charging device 2, an exposure device 3, a developing device 4, a drum cleaning device 6, and the like, which are described later. FIG. 2 is a schematic sectional view of the image forming portion 10.

The photosensitive drum 1 which is a drum-type (cylindrical) photosensitive drum 1 as a first image bearing member is movable (rotatable) while carrying an electrostatic image (electrostatic latent image). The photosensitive drum 1 includes an aluminum cylinder as a substrate and a surface layer (photosensitive layer) formed on a surface thereof. When an image forming operation is started, the photosensitive drum 1 is rotationally driven at a predetermined peripheral speed (process speed) in an arrow R1 direction (counterclockwise direction) by drum a driving motor D1 (FIG. 3) as a driving means. A surface of the rotating photosensitive drum 1 is electrically charged uniformly to a predetermined polarity (negative polarity in this embodiment) and a predetermined potential by the charging device 2 as a charging means. In this embodiment, the charging device 2 is a scorotron charger provided opposed to the photosensitive drum 1. During the charging, to a charging wire of the charging device 2, a predetermined charging bias (charging voltage) is applied by a charging power source E1 (FIG. 3) as a charging voltage applying means (charging voltage applying portion). By this, the charging device 2 causes electric discharge, and electrons generated by this discharge charge the surface of the photosensitive drum 1. The charged surface of the photosensitive drum 1 is subjected to scanning exposure to light on the basis of image information (image signal) by the exposure device 3 as an exposure means, so that an electrostatic image is formed on the photosensitive drum 1. In this embodiment, the exposure device 3 is a laser scanner. The exposure device 3 emits laser light in accordance with image information of separated color outputted from a controller 120 (FIG. 3), and subjects the surface (outer peripheral surface) of the photosensitive drum 1 to the scanning exposure.

The electrostatic image formed on the photosensitive drum 1 is developed (visualized) by being supplied with toner as a developer by the developing device 4 as a developing means, so that a toner image (toner picture, developer image) is formed on the photosensitive drum 1. In this embodiment, the developing device 4 develops the electrostatic image with a two-component developer, as a developer, provided with non-magnetic toner particle (toner) and magnetic carrier particles (carrier). The developing device 4 includes a developing sleeve 41 as a developer carrying member (developing member) and a developing container 42 for accommodating the developer. The developing sleeve 41 carries the developer in the developing container 42 and then conveys the developer toward a developing region opposing the photosensitive drum 1. During the development, to the developing sleeve 41, a predetermined developing bias (developing voltage) is applied by a developing power source E2 (FIG. 3) as a developing voltage applying means (developing voltage applying portion). In this embodiment, the toner charged to the same polarity as a charge polarity (negative polarity in this embodiment) of the photosensitive drum 1 is deposited on an exposed portion (image portion) of the photosensitive drum 1 where an absolute value of the potential is lowered by exposing the surface of the photosensitive drum 1 to light after the photosensitive drum 1 is uniformly charged (reverse development type). In this embodiment, a normal charge polarity of toner which is a principal charge polarity of the toner during the development is a negative polarity.

An intermediary transfer unit 7 is provided so as to oppose the four photosensitive drums 1Y, 1M, 1C, and 1K. The intermediary transfer unit 7 is constituted by including the intermediary transfer belt 70, an inner secondary transfer roller 71, a driving roller 72, a tension roller 73, primary transfer rollers 5Y, 5M, 5C, and 5K, and the like. The intermediary transfer belt 70 which is an intermediary transfer member constituted by an endless belt as a second image bearing member is movable (rotatable) while carrying a toner image. The intermediary transfer belt 70 is extended around and stretched at a predetermined tension by, as a plurality of stretching rollers (supporting rollers), the inner secondary transfer roller 71, the driving roller 72, and the tension roller 73. The driving roller 72 is rotationally driven by an intermediary transfer belt driving motor D2 (FIG. 3) as a driving means. To the intermediary transfer belt 70, a driving force is transmitted by the driving roller 72, and the intermediary transfer belt 70 is rotated (circumferential movement) in an arrow R2 direction (counterclockwise direction) in FIG. 1 at a predetermined peripheral speed (process speed) corresponding to the peripheral speed of the photosensitive drum 1. The tension roller 73 imparts a predetermined tension to the intermediary transfer belt 70. The inner secondary transfer roller 71 forms a secondary transfer portion N2 in a cooperation with an outer secondary transfer roller 81 described later. On the inner peripheral surface side of the intermediary transfer belt 70, the primary transfer rollers 5Y, 5M, 5C, and 5K which are roller-type primary transfer members as primary transfer means are disposed correspondingly to the respective photosensitive drums 1Y, 1M, 1C, and 1K. The primary transfer roller 5 presses the intermediary transfer belt 70 toward an associated photosensitive drum 1, whereby a primary transfer portion (primary transfer nip) N1 where the photosensitive drum 1 and the intermediary transfer belt 70 contact each other is formed. The stretching rollers, for the intermediary transfer belt 70, other than the driving roller 72, and the respective primary transfer rollers 5 are rotated with rotation of the intermediary transfer belt 70.

The toner image formed on the photosensitive drum 1 is transferred (primarily-transferred) onto the rotating intermediary transfer belt 7 as a toner image receiving member in the primary transfer portion N1 by the action of the primary transfer roller 5. During the primary transfer, to the primary transfer roller 5, a primary transfer bias (primary transfer voltage) which is a DC voltage of an opposite polarity (positive polarity in this embodiment) to the normal charge polarity of the toner is applied by a primary transfer power source E3 (FIG. 3) as a primary transfer voltage applying means (primary transfer voltage applying portion). To the primary transfer roller 5, the primary transfer bias of the positive polarity is applied, whereby the toner image formed of the toner of the negative polarity on the photosensitive drum 1 is transferred onto the intermediary transfer belt 70. For example, during full-color image formation, the color toner images of yellow, magenta, cyan, and black formed on the respective photosensitive drums 1 are successively transferred superposedly onto the intermediary transfer belt 70, so that a multiple toner image is formed on the intermediary transfer belt 70.

Here, in this embodiment, the primary transfer roller 5 includes a core metal and an elastic layer formed with an ion-conductive foamed rubber (NBR rubber (nitrile rubber)) and ECO rubber (epichlorohydrin rubber) so as to coat an outer periphery of the core metal. An outer diameter of the primary transfer roller 5 is, for example, 15-20 mm. Incidentally, herein, as regards numerical value ranges, “-” means that numerical values before and after “-” are included in the associated numerical value range. Further, as the primary transfer roller 5, a roller having an electric resistance value of 1×10⁵-1×10⁸Ω measured in N/N (23° C./50% RH) environment under application of a voltage of 2 kV may suitably be used.

Further, in this embodiment, the intermediary transfer belt 70 is constituted by an endless belt having a three-layer structure of a base layer, an elastic layer, and a surface layer from the inner peripheral surface side. As a material constituting the base layer, it is possible to suitably use a material obtained by incorporating carbon black or the like in an appropriate amount into a resin such as polyimide or polycarbonate or into various rubbers or the like. A thickness of the base layer is, for example, 0.05-0.15 mm. As a material constituting the elastic layer, it is possible to cite natural rubber, styrene-butadiene rubber, butadiene rubber, isoprene rubber, nitrile rubber, chloroprene rubber, butyl rubber, ethylene-propylene rubber, chlorosulfonated rubber, acrylate rubber, epichlorohydrin rubber, methane rubber, silicone rubber, fluorocarbon rubber, and the like. In this embodiment, urethane rubber was used. A thickness of the elastic layer may preferably be 100-2000 μm, more preferably 200-800 μm in order to improve a transfer property of a toner image onto, for example, a recording material S having unevenness by sufficiently utilizing flexibility thereof. As material constituting the surface layer, a resin such as fluorocarbon resin can be suitably used. The surface layer decreases a depositing force of the toner onto the surface of the intermediary transfer belt 70, and thus makes the toner easy to be transferred onto the recording material S in the secondary transfer portion N2. A thickness of the surface layer is, for example, 0.0002-0.020 mm. Further, as a base material of the surface layer, it is possible to use, for example, a resin material of a single kind, such as polyurethane, polyester, or epoxy resin, or materials of two or more kinds selected from elastic materials such as elastomers including elastic rubber, polyurethane, and the like. Further, to this base material, as a material for enhancing a lubricating property by reducing surface energy, it is possible to disperse powder or particles of, for example, fluorocarbon resin such as PTFE, PVDF, or PFA, silicone resin, and the like in a manner such that the these materials are dispersed singly or in combination of two or more kinds or in the form of different particle sizes. By this, the surface layer can be formed. In this embodiment, the intermediary transfer belt 70 is 1×10⁸-1×10¹⁴Ω·cm (23° C., 50% RH) in volume resistivity. Incidentally, the intermediary transfer belt 70 has the three-layer structure in this embodiment, but may also have, for example, a single-layer structure of a material corresponding to the above-described base layer, a two-layer structure consisting of the above-described base layer and the above-described surface layer, or the like layer structure.

On an outer peripheral surface side of the intermediary transfer belt 70, a secondary transfer unit 8 is provided so as to oppose the inner secondary transfer roller 71. The secondary transfer unit 8 includes a secondary transfer belt 80 constituted by an endless belt and an outer secondary transfer roller (secondary transfer roller) 81 provided in a position opposing the inner secondary transfer roller 71 on the inner peripheral surface side of the secondary transfer belt 80. The outer secondary transfer roller 81 is pressed toward the inner secondary transfer roller 71 and is contacted to the inner secondary transfer roller 71 through the secondary transfer belt 80 and the intermediary transfer belt 70. By this, the outer secondary transfer roller 81 forms the secondary transfer portion (secondary transfer nip) N2 which is a contact portion between the intermediary transfer belt 70 and the secondary transfer belt 80. Each of the inner secondary transfer roller 71 and the outer secondary transfer roller 81 is an example of a roller-type secondary transfer member as a secondary transfer means.

The toner image formed on the intermediary transfer belt 70 is transferred (secondarily transferred) in the secondary transfer portion N2 onto the recording material S nipped and conveyed by the intermediary transfer belt 70 and the secondary transfer belt 80. In this embodiment, during the secondary transfer, to the inner secondary transfer roller 71, a secondary transfer bias (secondary transfer voltage) which is a DC voltage of the same polarity (negative polarity in this embodiment) as the normal charge polarity of the toner is applied by a secondary transfer power source E4 as a secondary transfer voltage applying means (secondary transfer voltage applying portion). Further, in this embodiment, the outer secondary transfer roller 81 is connected to the ground (ground potential) (i.e., is electrically grounded).

Here, in the secondary transfer portion N2, the toner image on the intermediary transfer belt 70 is secondarily transferred onto the recording material S, and in addition, the recording material S is adsorbed to the secondary transfer belt 80 by a supplied electrostatic force.

For example, through the secondary transfer portion N2, a current of 40-60 μA is caused to flow. As the inner secondary transfer roller 71, for example, a roller including an elastic layer of an ion-conductive foamed rubber and a core metal and having an outer diameter of 24 mm and a roller surface roughness Rz of 6.0 to 12.0 (μm) can be used. Further, as the inner secondary transfer roller 71, for example, a roller having a resistance value of 1×10⁵ to 1×10⁷Ω measured in an environment of N/N (23°C/50% RH) under application of a voltage of 2 kV and including an elastic layer having Asker-C hardness of about 30 to 40 can be used. To the inner secondary transfer roller 71, a secondary transfer power source E4 of which supply bias is variable is connected. Details of the secondary transfer unit 8 will be described later.

The recording materials (transfer materials, recording media, sheet) S are accommodated in cassettes 11a and 11b. The recording material S is fed from either one of the cassettes 11a and 11b to a feeding/conveying path 13 as a recording material conveying path by a feeding member 12a or 12b, and then is conveyed toward a registration roller pair 14 as a conveying member. This recording material S is timed to the toner image on the intermediary transfer belt 70 by the registration roller pair 14 and then is conveyed toward the secondary transfer portion N2. The registration roller pair 14 is rotationally driven by transmitting thereto a driving force from a conveyance driving motor D4 (FIG. 3) as a driving means. Further, in this embodiment, a pre-charging device 9 for electrically charging a surface of the recording material S, onto which the toner image is transferred, before the recording material S reaches the secondary transfer portion N2 is provided upstream of the secondary transfer portion N2 (and downstream of the registration roller pair 14) with respect to a conveying direction of the recording material S. This pre-charging device 9 is provided upstream of the secondary transfer portion N2 (downstream of the registration roller pair 14) with respect to the conveying direction of the recording material S. Details of the pre-charging device 9 will be described later.

The recording material S on which the toner image is transferred is conveyed to a fixing device 15 as a fixing means by a conveying belt 19 as a conveying member. The fixing device 15 includes a fixing roller 15a and a pressing belt unit 15b. The fixing roller 15a incorporates a heater as a heating means therein. The recording material S on which an unfixed toner image is carried is heated and pressed by being nipped and conveyed between the fixing roller 15a and the pressing belt unit 15b. By this, the toner image is fixed (fused, stuck) on the recording material S.

In the case of an operation in a one-side printing mode, the recording material S on which the toner image is fixed on one side (surface) thereof as described above passes through a discharge conveying path 16 as a recording material conveying path and then is discharged (outputted) onto a discharge tray 21 as a discharge portion through a post-processing portion 20. In the case of an operation in a double-side printing mode, the recording material S on which the toner image is fixed on one side (surface) as described above is conveyed to the secondary transfer portion N2 again in order to transfer the toner image onto a second side (surface) of the recording material S. That is, in the operation in the double-side printing mode, the recording material S on which the toner image is fixed on the first side thereof is sent toward a reverse conveying path 17 as a recording material conveying path and is subjected to a switch-back operation in the reverse conveying path 17, so that a leading end and a trailing end of the recording material S are replaced with each other, and then the recording material S is conveyed again to the feeding/conveying path 13. The recording material S conveyed to the feeding/conveying path 13 is conveyed to the registration roller pair 14 and then is conveyed again to the secondary transfer portion N2. Then, on this recording material S, similarly as described above, a toner image is transferred onto a second side (surface) and then is fixed, and thereafter, the recording material S is discharged onto the discharge tray 21.

Further, the toner (primary transfer residual toner) remaining on the photosensitive drum 1 after the primary transfer is removed and collected from the surface of the photosensitive drum 1 by the drum cleaning device 6 as a photosensitive member cleaning means. Further, a deposited matter such as the toner (secondary transfer residual toner) remaining on the intermediary transfer belt 70 after the secondary transfer is removed and collected from the surface of the intermediary transfer belt 70 by a belt cleaning device 74 as an intermediary transfer member cleaning means.

### 2. Control Constitution

FIG. 3 is a blocked diagram showing an outline of a control constitution of the image forming apparatus in this embodiment. The image forming apparatus 100 includes a controller (control circuit) 120 for controlling the image forming apparatus 100. The controller 120 is constituted by including a CPU 121 as arithmetic processing means (arithmetic processing portion), a memory (storing medium) 122 such as a ROM or a RAM as a storing means (storing portion), and an input/output portion (not shown) for performing input/output of information between the controller 120 and an external device. The CPU 121 and the memory 122 are capable of transferring and reading of data therebetween.

In the ROM, a control program, a data table acquired in advance, and the like are stored. In the RAM which is a rewritable memory, information inputted to the controller 120, detected information, a calculation result, and the like are stored.

To the controller 120, the respective portions of the image forming apparatus 100 are connected. The controller 120 controls the respective portions of the image forming apparatus 100 and causes the image forming apparatus 100 to execute various operations such as the image forming operation.

For example, to the controller 120, various power sources such as the charging power source E1, the developing power source E2, the primary transfer power source E3, the secondary transfer power source E4, the pre-charging power source E5, a first cleaning power source E6, and a second cleaning power source E7 are connected. Further, to the controller 120, various driving portions such as the drum driving motor D1, the intermediary transfer belt driving motor D2, and a secondary transfer belt driving motor D3 described later are connected.

Further, to the controller 120, an environment sensor 18 is connected. The environment sensor 18 is an example of an environment detecting means for detecting an environment (installation environment of the image forming apparatus 100) which is at least one of a temperature and a humidity inside or outside the image forming apparatus 100. In this embodiment, the environment sensor 18 is constituted by a temperature/humidity sensor for detecting a temperature and a humidity (relative humidity) inside the image forming apparatus 100 (inside the cassettes 11a and 11b or in the neighborhood of the cassettes 11a and 11b). That is, the environment sensor 18 includes a temperature sensor and a humidity sensor.

The environment sensor 18 inputs, to the controller 120, signals showing detection results of the temperature and the humidity. On the basis of the temperature and the humidity detected by the environment sensor 18, the controller 120 calculates an absolute water content (absolute humidity) as temperature/humidity information in an environment, and can use the calculated absolute water content in the control. Even when an atmospheric environment abruptly changes, an electric resistance value of the recording material S is not abruptly changed in many cases. For that reason, by providing the environment sensor 18 inside the cassettes 11a and 11b or in the neighborhood of the cassette 11a and 11b, a change in electric resistance of the recording material S can be grasped more accurately.

To the secondary transfer power source E4, a voltage detecting sensor 25a as a voltage detecting means (voltage detecting portion) for detecting an output voltage thereof and a current detecting sensor 25b as a current detecting means (current detecting portion) for detecting an output current thereof are connected. The voltage detecting sensor 25a is capable of detecting a voltage applied to the inner secondary transfer roller 71 (secondary transfer portion N2). The current detecting sensor 25b is capable of detecting a current flowing through the inner secondary transfer roller 71 (secondary transfer portion N2). The voltage detecting sensor 25a and the current detecting sensor 25b input signals indicating detection results of the voltage and the current, respectively, to the controller 120. The controller 120 is capable of executing secondary transfer voltage control (ATVC) described later or the like on the basis of the detection results of the voltage detecting sensor 25a and the current detecting sensor 25b.

Further, the controller 120 is capable of recognizing a timing when a region on the secondary transfer belt 80 pre-charged in a pre-charging portion N3 described later when the pre-charging bias is turned on or off reaches the secondary transfer portion N2. This timing can be acquired from a timing of turning-on or-off of the pre-charging bias, a driving speed of the secondary transfer belt 80, a distance from the pre-charging portion N3 to the secondary transfer portion N2, and the like. Further, information on this timing may be acquired and stored in advance in the memory 122 or may be incorporated into a control program.

Further, to the controller 120, an operating portion (operating panel) 130 provided to the image forming apparatus 100 is connected. The operating portion 130 is constituted by including a display portion for displaying various pieces of information to an operator such as a user or a service person by control by the controller 120, and an input portion for inputting, to the controller 120, various settings relating to image formation and the like by the operator. The operating portion 130 may be constituted by a touch panel or the like having functions of the display portion and the input portion. Further, to the controller 120, an image reading apparatus (not shown) provided to the image forming apparatus 100 or connected to the image forming apparatus 100, and an external device 200 such as a personal computer may be connected.

Incidentally, in this embodiment, although illustration is omitted, the charging power source E1, the developing power source E2, and the primary transfer power source E3 are provided independently of each other. Further, the drum driving motor D1 may be provided independently of the photosensitive drum 1, or may be provided in common to all or a part of the photosensitive drums 1. Further, all or a part of the drum driving motor D1, the intermediary transfer belt driving motor D2, and the secondary transfer belt driving motor D3, the conveyance driving motor D4 may be made common.

Here, the image forming apparatus 100 executes a job (image output operation print job) which is a series of operations started by a single start instruction and in which the image is formed and outputted on a single recording material S or a plurality of recording materials S. The job includes an image forming step, a pre-rotation step, a sheet (paper) interval step in the case where images are formed on the plurality of recording materials S, and a post-rotation step in general. The image forming step is a period in which formation of an electrostatic image for the image actually formed and outputted on the recording material S, formation of the toner image, and primary transfer and secondary transfer of the toner image are carried out, and during image formation (image forming period) refers to this period. Specifically, timings during the image formation are different among positions where the respective steps of the formation of the electrostatic image, the formation of the toner image, and the primary transfer and secondary transfer of the toner image and the fixing are performed. The pre-rotation step is a period in which a preparatory operation, before the image forming step, from an input of the start instruction until the image is started to be actually formed. The sheet interval step is a period corresponding to an interval between a recording material S and a subsequent recording material S when the images are continuously formed on a plurality of recording materials S (continuous image formation). The post-rotation step is a period in which a post-operation (preparatory operation) after the image forming step is performed. During non-image formation (non-image forming period) is a period other than during image formation and includes the pre-rotation step, the sheet interval step, the post-rotation step and further includes a pre-multi-rotation step which is a preparatory operation during turning-on of a main switch (power source) of the image forming apparatus 100 or during restoration from a sleep state.

Incidentally, in this embodiment, the controller 120 includes, as functional blocks, a pre-image formation preparation process portion, an ATVC process portion, an image forming process portion, and the like. Further, the controller 120 includes, as the functional blocks, a primary transfer voltage storing portion/arithmetic portion, a secondary transfer voltage storing portion/arithmetic portion, and the like. These process portions and the storing portions/arithmetic portions may be provided as a part of the CPU 121 or the memory 122 (RAM). The controller 120 (specifically, the image forming process portion) is capable of executing the job as described above.

Further, the controller 120 (specifically, the ATVC process portion) is capable of executing the ATVC of the secondary transfer portion (and the primary transfer portion) described later.

### 3. Secondary Transfer Unit

Next, the secondary transfer unit (secondary transfer device) 8 in this embodiment will be described.

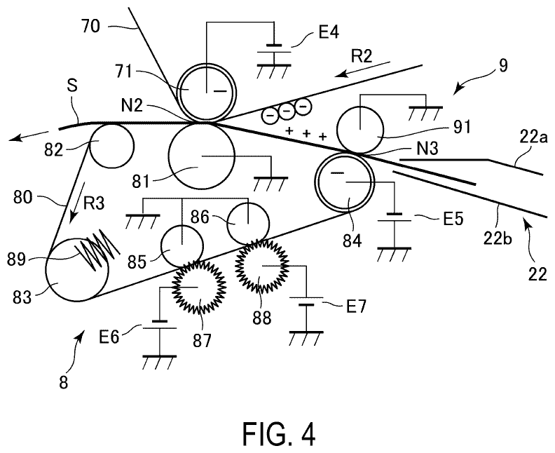

FIG. 4 is a schematic sectional view (showing a cross section substantially perpendicular to a rotational axis direction of the photosensitive drum 1 or rotational axis directions of the stretching rollers for the secondary transfer belt 80) showing the neighborhood of the secondary transfer portion N2 in this embodiment. Incidentally, as regards the secondary transfer belt 80 and the stretching rollers for the secondary transfer belt 80, “upstream” and “downstream” refer to “upstream” and “downstream”, respectively, with respect to a rotational direction (surface movement direction) of the secondary transfer belt 80.

The secondary transfer unit 8 includes the secondary transfer belt 80 constituted by an endless belt as a recording material carrying member. The secondary transfer belt 80 is extended around and stretched at a predetermined tension by a plurality of stretching rollers (supporting rollers). In this embodiment, the secondary transfer unit 8 includes, as the stretching rollers provided on the inner peripheral surface side of the secondary transfer belt 80, an outer secondary transfer roller 81, a separation roller 82, a tension roller 83, and a driving roller (secondary transfer belt driving roller) 84. Further, in this embodiment, the secondary transfer unit 8 includes first and second cleaning opposite rollers 85 and 86 as stretching rollers provided on the inner peripheral surface side of the secondary transfer belt 80. Rotational axis directions of the outer secondary transfer roller 81, the separation roller 82, the tension roller 83, the driving roller 84, and the first and second cleaning opposite rollers 85 and 86 are substantially parallel to each other. Further, these rotational axis directions of the stretching rollers for the secondary transfer belt 80 are substantially parallel to the rotational axis direction of the photosensitive drum 1 and the rotational axis directions of the stretching rollers for the intermediary transfer belt 70.

As the secondary transfer belt 80, for example, a secondary transfer belt formed of a resin material adjusted in volume resistivity to 1×10⁹-1×10¹⁴Ω·cm (23° C., 50% RH) by incorporating carbon black as an antistatic agent in an appropriate amount into a resin such as polyimide, polycarbonate, or the like can be used. Further, as the secondary transfer belt 80, a secondary transfer belt sufficiently hard such that a value of Young's modulus measured by a tensile test method (JIS K 6301) is about 100 MPa or more and 10 GPa or less can be used. The secondary transfer belt 80 may have a single-layer structure or a multi-layer structure. A thickness of the secondary transfer belt 80 is about 0.07-0.1 mm, for example. Further, a peripheral length of the secondary transfer belt 80 is about 300 mm, for example.

The outer secondary transfer roller 81 is disposed opposed to the inner secondary transfer roller 71 through the secondary transfer belt 80 and the intermediary transfer belt 70. The outer secondary transfer roller 81 is pressed toward the inner secondary transfer roller 71 by a pressing mechanism (not shown). The outer secondary transfer roller 81 is contacted to the inner secondary transfer roller 71 through the secondary transfer belt 80 and the intermediary transfer belt 70. By this, the secondary transfer belt 80 and the intermediary transfer belt 70 are sandwiched by the outer secondary transfer roller 81 and the inner secondary transfer roller 71, so that the secondary transfer portion N2 which is a contact portion between the intermediary transfer belt 70 and the secondary transfer belt 80 is formed. In this embodiment, the outer secondary transfer roller 81 includes a core metal and an elastic layer formed with ion-conductive foamed rubber (NBR rubber and ECO rubber) so as to coat an outer periphery of the core metal. An outer diameter of the outer secondary transfer roller 81 is, for example, 15-35 mm. By this, a sufficient nip (secondary transfer portion) N2 can be formed as the secondary transfer portion N2. Further, as the outer secondary transfer roller 81, it is possible to suitably use a roller having an electric resistance value of 1×10⁷-1×10⁸Ω (as measured in N/N (23° C./50% RH) environment under application of a voltage of 2 kV). In the contact portion between the inner secondary transfer roller 71 and the outer secondary transfer roller 81 through the intermediary transfer belt 70 and the secondary transfer belt 80, by a contact force thereof, the elastic layer of the outer secondary transfer roller 81 lower in hardness than the inner secondary transfer roller 71 is elastically deformed.

The separation roller 82 is disposed adjacently to (immediately downstream of) the outer secondary transfer roller 81 on a side downstream of the outer secondary transfer roller 81. By the separation roller 82 and the outer secondary transfer roller 81, a recording material carrying surface (conveying surface) which is an outer peripheral surface of the secondary transfer belt 80 for carrying and conveying the recording material S is formed. The recording material S passed through the secondary transfer portion N2 and electrostatically attracted to the recording material carrying surface of the secondary transfer belt 80 is conveyed by the secondary transfer belt 80, and thereafter, is peeled off from the secondary transfer belt 80 by utilizing curvature of the separation roller 82. By this, the recording material S is delivered from the secondary transfer belt 80 to the conveying belt 19. In this embodiment, the separation roller 82 is constituted by a metal roller.

The tension roller (secondary transfer belt tension roller) 83 is disposed adjacently to (immediately downstream of) the separation roller 82 on a side downstream of the separation roller 82. The tension roller 83 is pressed from the inner peripheral surface side toward the outer peripheral surface side of the secondary transfer belt 80 by a pressing spring 89 which is an urging member as an urging means, and thus imparts a predetermined tension to the secondary transfer belt 80. In this embodiment, the tension roller 83 is constituted by a metal roller.

The driving roller (secondary transfer belt driving roller) 84 is disposed adjacently to (immediately upstream of) the outer secondary transfer roller 81. By the outer secondary transfer roller 81 and the driving roller 84, a recording material carrying surface (conveying surface) which is an outer peripheral surface of the secondary transfer belt 80 for carrying and conveying the recording material S is formed. In this embodiment, the driving roller 84 includes a core metal, and an elastic layer formed with EPDM rubber (ethylene-propylene(-diene-methylene) rubber) sufficiently low in electric resistance so as to coat an outer periphery of the core metal. By this, electrical conduction between the driving roller 84 and a pre-charging opposite roller 91 described later is established. In this embodiment, an outer diameter of the core metal of the driving roller 84 is 20 mm. Further, in this embodiment, a thickness of the EPDM rubber constituting the elastic layer of the driving roller 84 is 0.5 mm, and a surface thereof is polished and managed so that a surface roughness is substantially constant. The driving roller 84 is rotationally driven by the secondary transfer belt driving motor D3 (FIG. 3) as a driving means. To the secondary transfer belt 80, a driving force is transmitted by the driving roller 84, so that the secondary transfer belt 80 is rotated (circumferential movement) at a predetermined peripheral speed corresponding to the peripheral speed of the intermediary transfer belt 70 in an arrow R3 direction (counterclockwise direction) in FIG. 4. The stretching rollers, for the secondary transfer belt 80, other than the driving roller 84 are rotated with rotation of the secondary transfer belt 80. Incidentally, a roller to which the driving means for conveying the secondary transfer belt 80 is not limited to the driving roller 84 in this embodiment, but may only be required to be either one of rollers contacting the inner peripheral surface of the secondary transfer belt 80. Further, the secondary transfer unit 8 may also be constituted so that the secondary transfer belt 80 is rotated with rotation of the intermediary transfer belt 70.

The first and second cleaning opposite rollers 85 and 86 are disposed on a side downstream of the tension roller 83 and upstream of the driving roller 84, and the first cleaning opposite roller 85 is disposed upstream of the second cleaning opposite roller 86. Further, the secondary transfer unit 8 includes first and second brush rollers 87 and 88 as first and second secondary transfer belt cleaning members in positions opposing the first and second cleaning opposite rollers 85 and 86, respectively on the outer peripheral surface side of the secondary transfer belt 80. To the first brush roller 87, a cleaning bias (cleaning voltage) of the same polarity (negative polarity in this embodiment) as the normal charge polarity is applied from a first cleaning power source E6. Further, to the second brush roller 88, a cleaning bias (cleaning voltage) of an opposite polarity (positive polarity in this embodiment) to the normal charge polarity is applied from a second cleaning power source E7. Each of the first and second cleaning opposite rollers 85 and 86 is electrically grounded. By this, a deposited matter such as toner of the opposite polarity to the normal charge polarity of the toner deposited on the surface of the secondary transfer belt 80, or the like is collected by the first brush roller 87. Further, a deposited matter such as toner of the same polarity as the normal charge polarity of the toner deposited on the surface of the secondary transfer belt 80, or the like is collected by the second brush roller 88. The deposited matters collected by the first and second brush rollers 87 and 88 are removed from the first and second brush rollers 87 and 88 by a collecting member (not shown) or the like, and are accommodated in the collecting member (not shown) or the like. Thus, the surface of the secondary transfer belt 80 can be electrostatically cleaned.

In this embodiment, to the core metal of the inner secondary transfer roller 71, the secondary transfer power source E4 is connected. Further, to the inner secondary transfer roller 71, the secondary transfer bias of the same polarity (negative polarity in this embodiment) as the normal charge polarity of the toner is applied by the secondary transfer power source E4. Further, in this embodiment, the core metal of the outer secondary transfer roller 81 is connected to the ground, so that the outer secondary transfer roller 81 is electrically grounded. Here, such an energizing type that the secondary transfer bias is applied from a side where the toner image is transferred onto the surface of the recording material S is referred to as an “inner energization type”. On the other hand, such an energization type that the secondary transfer bias is applied from a side opposite from the side where the toner image is transferred onto the recording material S is referred to as an “outer energization type”. In the case of the outer energization type, for example, the inner secondary transfer roller 71 is electrically grounded, and to the outer secondary transfer roller 81, the secondary transfer bias of the opposite polarity to the normal charge polarity of the toner is applied.

The inner energization type is improved compared with the outer energization type in a transfer property of the toner image onto a recording material S (low-resistance recording material) low in electric resistance, such as metallic foil paper. This is due to the following reason. In the outer energization type, in the case where the electric resistance of the recording material S is low and leakage of a transfer current to a member or the like in the neighborhood of the secondary transfer portion N2 through the recording material S occurs, the transfer current escapes to the above-described member without contributing to the transfer between the recording material S and the intermediary transfer belt 70. On the other hand, in the inner energization type, even in the case where the electric resistance of the recording material S is low and leakage of the transfer current to the member or the like in the neighborhood of the secondary transfer portion N2 through the recording material S occurs, the transfer current escapes to the above-described member after the transfer current contributes to the transfer between the recording material S and the intermediary transfer belt 70. For that reason, the inner energization type is improved compared with the outer energization type in transfer property of the toner image to the recording material S low in electric resistance.

In this embodiment, the secondary transfer bias is applied by constant-voltage control. A voltage value Vtr (set voltage, target voltage) of the secondary transfer bias is determined to a voltage value which is the sum of a base voltage Vb for obtaining a predetermined transfer current and a recording material part voltage Vp determined depending on a kind of the recording material S. The recording material part voltage Vp is set in advance depending on the kind of the recording material S and in addition, depending on an environment (for example, an absolute water content), and then is stored as table data or the like in the memory 122.

The base voltage Vb can be acquired, for example, by control called secondary transfer voltage determination control or ATVC (Active Transfer Voltage Control). The ATVC is typically executed every job in the pre-rotation step or the pre-multi-rotation step, but may be executed at an arbitrary timing (sheet interval step or the like) when the timing is during non-image formation such that the toner image and the recording material S are absent in the secondary transfer portion N2. Details of the ATVC will be described later.

Here, the constant-current control is control in which an output of a power source is adjusted so that a current supplied to a supply object becomes substantially constant at the target current. Further, the constant-voltage control is control in which the output of the power source is adjusted so that a voltage applied to an application object becomes substantially constant at the target voltage. Further, the kind of the recording material S includes arbitrary information capable of discriminating the recording material S, inclusive of attributes (so-called paper kind category) based on general features such as plain paper, coated paper, thick paper, an synthetic paper; numerical values and numerical value ranges such as a basis weight and a thickness; brands (including manufactures, product numbers, and the like); and so on. In general, the kind of the recording material S is identified by the paper kind category and the thickness (or the basis weight) in many cases.

### 4. Pre-Charging Device

Next, the pre-charging device (recording material charging device) 8 in this embodiment will be further described.

As described above, in the image forming apparatus, depending on the specifications of the recording material, there is a possibility that an image defect such as a transfer void or poor density due to shortage of the transfer current. Recently, for example, in a production machine of an intermediary transfer type, there is a tendency that the kind of the recording material used in the image formation increases. For example, in the production machine high in image forming speed, there are cases where it is difficult to properly secondarily transfer the toner image onto a recording material (high-resistance recording material), without lowering productivity, such as ultra-thick paper (high-resistance paper) or synthetic paper high in electric resistance due to that the synthetic paper includes a resin layer.

For example, in a low-humidity environment, the electric resistance of the outer secondary transfer roller becomes high, and therefore, there is a need that an absolute value of a voltage of the secondary transfer bias for passing a necessary transfer current is made large. There are cases where the absolute value of the voltage of the secondary transfer bias is required to be made 10 kV or more. In such cases where the secondary transfer bias exceeds a high-voltage capacitance, there is a possibility that the transfer void or the poor density due to the shortage of the transfer current occurs. This transfer void or the poor density occurs, for example, in a secondary-color toner image. Further, a high-voltage power source capable of applying such a secondary transfer bias is expensive, so that there is a possibility that the high-voltage source becomes a factor of an increase in cost of the image forming apparatus. Further, even when such a high-voltage source is intended to be used, due to convenience of arrangement, a creepage surface cannot be ensured in some cases, so that the secondary transfer bias large in absolute value of the voltage as described above cannot be applied in some cases. Further, when the absolute value of the voltage of the secondary transfer bias is made large, an image defect due to an electric discharge phenomenon in the secondary transfer portion N2 occurs, so that it is difficult to obtain an appropriate image in some cases. As the image defect due to the discharge phenomenon, a stripe-shaped image defect and an image defect called a white void or penetration, which are caused due to that a part of the toner image is not transferred or that a part of the toner image is disturbed (scattered) occur in some instances.

Thus, for example, as regards a recording material S (high-resistance recording material) such as high-resistance paper higher in volume resistivity than plain paper, such as synthetic paper including a resin layer or ultra-thick paper, particularly in a low-humidity environment, only by the secondary transfer bias in the secondary transfer portion N2, it is difficult to sufficiently transfer the toner onto the recording material S. For that reason, there is a possibility that improper transfer occurs. Further, in the case where an absolute value of the voltage of the secondary transfer bias is required to be 10 kV or more, in view of a creeping distance or the like in the neighborhood of the secondary transfer portion N2, when an output of the secondary transfer power source E4 is increased, the increased output leads to upsizing of the image forming apparatus 100.

Therefore, in this embodiment, the image forming apparatus 100 is constituted so that a surface of the recording material S onto which the toner image is transferred is capable of being charged in advance to an opposite polarity to the normal charge polarity of the toner. The surface of the recording material S onto which the toner image is transferred is also referred to as a “toner image transfer surface” or a “transfer surface”. By this, even when the absolute value of the voltage of the secondary transfer bias is made relatively small, it becomes possible to appropriately transfer the toner image onto the recording material S by compensating for shortage of the transfer current.

As shown in FIG. 4, in this embodiment, in the image forming apparatus 100, the pre-charging device 9 for charging the toner image transfer surface of the recording material S to the opposite polarity to the normal charge polarity before the recording material S reaches the secondary transfer portion N2 is provided. Charging of the toner image transfer surface of the recording material S to the opposite polarity to the normal charge polarity in advance before the recording material S reaches the secondary transfer portion N2 is referred to as “pre-charging” or “recording material charging (or simply as “charging”). The pre-charging device 9 is provided upstream of the secondary transfer portion N2 (downstream of the registration roller pair 14) with respect to the conveying direction of the recording material S. By this, a transfer property of the toner image onto the ultra-thick paper or the synthetic paper can be improved.

In this embodiment, the pre-charging device 9 is constituted by including the driving roller (secondary transfer belt driving roller) 84 disposed on the inner peripheral surface side of the secondary transfer belt 80 and the pre-charging opposite roller 91 disposed opposed to the driving roller 84 through the secondary transfer belt 80. The driving roller (pre-charging roller, recording material charging roller) 84 in this embodiment is an example of a recording material charging member (pre-charging member). The driving roller 84 is a stretching roller for the intermediary transfer belt 70 and has a function of a driving roller for driving the secondary transfer belt 80 and a function of the recording material charging member in combination. Further, the pre-charging opposite roller 91 in this embodiment is an example of an opposite member (pre-charging opposite member).

The pre-charging opposite roller 91 forms a desired nip state with the driving roller 84 and nips the recording material S therebetween. That is, the driving roller 84 contacts the pre-charging opposite roller 91 through the secondary transfer belt 80. By this, the secondary transfer belt 80 is nipped by the driving roller 84 and the pre-charging opposite roller 91, so that a pre-charging portion (pre-charging nip, recording material charging portion) N3 which is a contact portion between the secondary transfer belt 80 and the pre-charging opposite roller 91 is formed. Incidentally, a length of a portion, where these rollers are contactable to the recording material S, in a rotational axis direction of the pre-charging opposite roller 91 is longer than a length, in the same direction, of the recording material S usable in the image forming apparatus 100 (i.e., the recording material S falls within a range of the lengths of the respective rollers in the rotational axis direction).

In this embodiment, the pre-charging opposite roller 91 is an elastic sponge roller including a core metal, and an elastic foamed member layer formed with the ion-conductive foamed rubber (NBR rubber, ECO rubber) sufficiently low in electric resistance so as to coat an outer periphery of the core metal. In this embodiment, an outer diameter of the pre-charging opposite roller 91 is 15 mm. The outer diameter of the pre-charging opposite roller 91 is, for example, about 5-30 mm, preferably 10-20 mm. Thus, the pre-charging opposite roller 91 is constituted by a relatively small-diameter roller, whereby a distance between the surface of the pre-charging opposite roller 91 and the surface of the intermediary transfer belt 70 can be sufficiently ensured. A distance from the pre-charging portion N3 to the secondary transfer portion N2 in the conveying direction of the recording material S is, for example, about 10-100 mm, preferably 30 mm or less. By this, in the case where the toner image transfer surface of the recording material S is charged in the pre-charging portion N3, it is possible to suppress attenuation of a charge amount of the toner image transfer surface of the recording material S in a period until the recording material S is conveyed to the secondary transfer portion N2.

In this embodiment, to the core metal of the driving roller 84, the pre-charging power source E5 as a pre-charging voltage applying means (pre-charging voltage applying portion) is connected. Further, to the driving roller 84, a pre-charging bias (recording material charging bias, pre-charging voltage) of the same polarity (negative polarity in this embodiment) as the normal charge polarity of the toner is applied by the pre-charging power source E5. Further, in this embodiment, the core metal of the pre-charging opposite roller 91 is connected to the ground, so that the pre-charging opposite roller 91 is electrically grounded. The pre-charging bias of the same polarity as the normal charge polarity of the toner is applied to the surface of the recording material S opposite from the toner image transfer surface of the recording material S, so that the surface of the recording material S opposite from the toner image transfer surface of the recording material S is charged to the same polarity (negative polarity in this embodiment) as the normal charge polarity of the toner. By this, the toner image transfer surface of the recording material S is charged to the opposite polarity (positive polarity in this embodiment) to the normal charge polarity of the toner by electric charges induced from the ground. At this time, a current apparently flows through the pre-charging portion N3. Details of the pre-charging bias will be described later.

The recording material S conveyed by the registration roller pair 14 is conveyed to the normal (pre-charging portion) N3 between the pre-charging opposite roller 91 and the secondary transfer belt 80 extended around the driving roller 84. Incidentally, in this embodiment, with respect to the conveying direction of the recording material S, a guiding member 22 (upper guiding member 22a, lower guiding member 22b) for guiding the recording material S is provided upstream of the pre-charging portion N3 and downstream of the registration roller pair 14. The recording material S conveyed by the registration roller pair 14 is conveyed toward the pre-charging portion N3 while being guided by the guiding member 22.

Then, in the pre-charging portion N3, the recording material S is charged (pre-charged), and in addition, the recording material S is electrostatically attracted to the secondary transfer belt 80 (by an electrostatic force). The recording material S attracted to the secondary transfer belt 80 is conveyed to the secondary transfer portion N2, where the toner image is transferred (secondarily transferred) onto the recording material S.

### 2. Control of Secondary Transfer Voltage

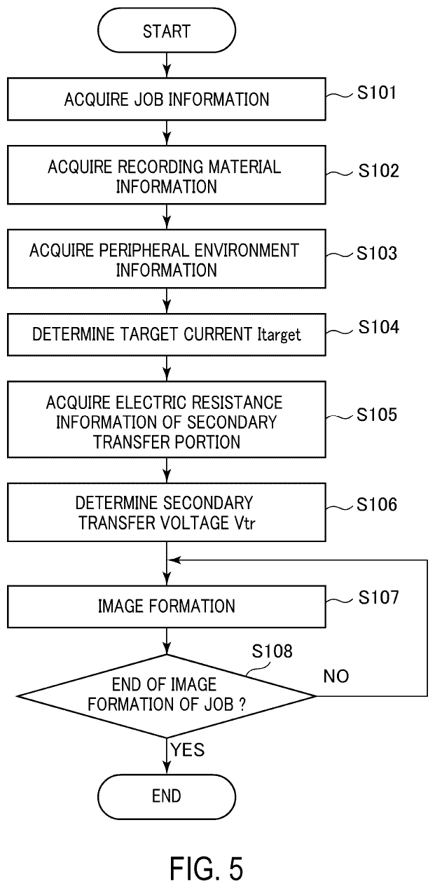

Next, a basic operation of the ATVC of the secondary transfer portion N2 will be described. Generally, the secondary transfer voltage control includes constant-voltage control and the constant-current control, but in this embodiment, the constant-voltage control is used. FIG. 5 is a flowchart for illustrating the basic operation of the ATVC of the secondary transfer portion N2.

First, the controller 120 (pre-image formation preparation process portion 31a) causes the image forming portion to start an operation of a job when acquires information on the job from the operating portion 130 or the external device 200 (S101). In the information on this job, image information designated by an operator and information on the recording material S (“recording material information”) are included. The recording material information may include a size (width, length) of the recording material S on which the image is to be formed, information (thickness, basis weight and the like) relating to the thickness of the recording material S, information relating to a surface property of the recording material S such that whether or not the recording material S is coated paper, and the like information. Particularly, in this embodiment, the recording material information includes information on the size of the recording material S and information on a category (so-called category of paper kind) of the recording material S such as “thin paper, plain paper, thick paper, synthetic paper, . . . ”. Incidentally, the recording material information includes any distinguishable pieces of information on the recording materials S, such as attributes (so-called the paper kind category) based on general characteristics including plain paper, high-quality paper, glossy paper (gloss paper), coated paper, embossed paper, thick paper, thin paper, and synthetic paper; numerical value or numerical value ranges such as a basis weight, a thickness, a size, and rigidity; or brands (including manufacturers, trade names, model names, and the like). It can be understood that the kind of the recording material S is constituted for each of the recording materials S distinguished by the recording material information. Further, the recording material information may be included in information on a print mode for designating operation setting of the image forming apparatus 1, such as “plain paper mode” or “thick paper mode” or may also be substituted by the information on the print mode. The controller 120 (pre-image formation preparation process portion 31a) writes this job information in the memory 122 (RAM) (S102).

Next, the controller 120 (image formation pre-preparation process portion) acquires environment information detected by the environment sensor 18 (S103). In the memory 122 (ROM), information showing correlation between the environment information and a target current Itarget for transferring the toner image from the intermediary transfer belt 70 onto the recording material S is stored. The controller 120 (secondary transfer voltage storage/arithmetic (operation) portion) acquires the target current Itarget corresponding to the environment from the information showing the correlation between the environment information and the target current Itarget, on the basis of the environment information read in S103. Then, the controller 120 writes this target current Itarget in the memory 122 (RAM) (or the secondary transfer voltage storage/arithmetic portion) (S104). Incidentally, why the target current Itarget is changed depending on the environment information is that the toner charge amount varies depending on the environment. The information showing the correlation between the environment information and the target current Itarget has been acquired in advance by an experiment or the like.

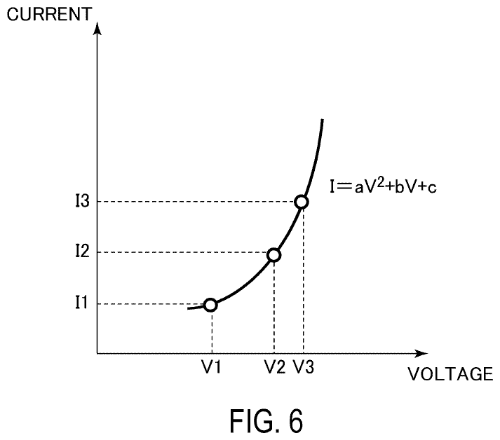

Next, the controller 120 (ATVC process portion) acquires information on an electric resistance (electric resistance information) of the secondary transfer portion N2 by the ATVC before the toner image on the intermediary transfer belt 70 and the recording material S onto which the toner image is transferred reach the secondary transfer portion N2 (S105). That is, in a state in which the secondary transfer belt 80 and the intermediary transfer belt 70 are made in contact with each other, predetermined voltages (test biases) of a plurality of levels are applied (supplied) from the secondary transfer voltage source E4 to the inner secondary transfer roller 71. Then, current values when the predetermined voltages are applied are detected by the current detecting sensor 25b, so that a relationship between the voltage and the current (voltage-current characteristic) as shown in FIG. 6 is acquired. Incidentally, predetermined currents (test biases) of a plurality of levels are supplied, and voltage values when the predetermined currents are supplied are detected by the voltage detecting sensor 25a, so that a voltage-current characteristic may be acquired. Both the predetermined voltages and the predetermined currents may also be used. The controller 120 writes information on this voltage-current characteristic in the memory 122 (RAM or the secondary transfer voltage storage/arithmetic operation portion). This voltage-current characteristic is an example of the electric resistance information which changes depending on the electric resistance of the secondary transfer portion N2. In the constitution of this embodiment, the voltage-current characteristic is not such that the current changes linearly relative to the voltage (i.e., is linearly proportional to the voltage), but is such that the current changes so as to be represented by a polynominal expression consisting of two or more terms of the voltage (quadratic expression in this embodiment). For that reason, in this embodiment, in order that the voltage-current characteristic can be represented by the polynominal expression, the number of predetermined voltages or currents supplied when the electric resistance information of the secondary transfer portion N is acquired was three or more (levels).

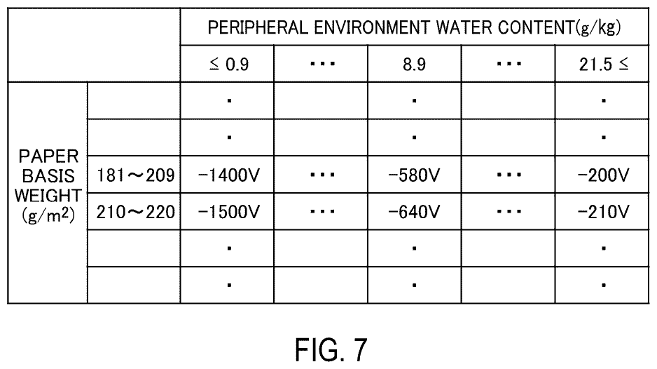

Then, the controller 120 (secondary transfer voltage storage/arithmetic operation portion) acquires a voltage value of the secondary transfer bias to be applied during the secondary transfer from the secondary transfer voltage source E4 to the inner secondary transfer roller 71 (S106). That is, on the basis of the target current Itarget written in the memory 122 (RAM) in S104 and the voltage-current characteristic acquired in S105, the controller 120 acquires a voltage value (base voltage) Vb necessary to cause the target current Itarget to flow in a state in which the recording material S is absent in the secondary transfer portion N2. This base voltage Vb corresponds to a secondary transfer portion part voltage (transfer voltage corresponding to the electric resistance of the secondary transfer portion N2). Further, in the memory 122 (ROM), information for acquiring a recording material part voltage (transfer voltage corresponding to the electric resistance of the recording material S) Vp as shown in FIG. 7 is stored. In this embodiment, this information is set as table data indicating a relationship between water content (absolute water content) and the recording material part voltage Vp in an ambient atmosphere for each of sections of basis weights of recording material S depending on paper kind categories. Incidentally, the controller 120 (pre-image formation pre-preparation process portion) is capable of acquiring ambient water content (absolute water content) on the basis of environment information (temperature, humidity) detected by the environment sensor 18. On the basis of the information on the job acquired in S101 and the environment information acquired in S103, the controller 120 (secondary transfer voltage storage/arithmetic portion) acquires the recording material part voltage Vp corresponding to these pieces of information from the above-described table data. Further, the controller 120 (secondary transfer storing portion/arithmetic portion) determines the voltage value (set voltage, target voltage) Vtr of the secondary transfer bias by a voltage value which is the sum of the base voltage Vb and the recording material part voltage Vp. The controller 120 (secondary transfer voltage storing portion/arithmetic portion) causes the memory 122 (RAM or secondary transfer voltage storing portion/arithmetic portion) to store the determined voltage value Vtr of the secondary transfer bias. Incidentally, in the case where an adjusting value is set by an operation in an adjusting mode for adjusting the set voltage of the secondary transfer bias, the controller 120 (secondary transfer storing portion/arithmetic portion) is capable of adjusting the set voltage of the secondary transfer bias by an adjusting amount ΔV depending on the adjusting value.

Incidentally, the table data for acquiring the recording material part voltage Vp as shown in FIG. 7 are acquired in advance by the experiment or the like. Here, the recording material part voltage Vp also changes depending on a surface property of the recording material S other than the information (thickness, basis weight or the like) relating to the thickness of the recording material S in some instances. For that reason, the table data may also be set so that the recording material part voltage Vp changes also depending on the information relating to the surface property of the recording material S. Further, in this embodiment, the information relating to the thickness of the recording material S (and in addition, the information relating to the surface property of the recording material S) are included in the job information acquired in S101. However, a measuring means for detecting the thickness of the recording material S and the surface property of the recording material S is provided in the image forming apparatus 100, and the recording material part voltage Vp may also be acquired on the basis of information acquired by this measuring means.

Next, the controller 120 (image formation process portion) causes the image forming portion to form the image and to send the recording material S to the secondary transfer portion N2 and carries out control so that the secondary transfer is performed by the voltage value Vtr of the secondary transfer voltage determined as described above (S107). Thereafter, the controller 120 (image formation process portion) repeats the processing of S107 until all the images in the job are transferred and completely outputted on the recording material S (S108).

Incidentally, also as regards the primary transfer portion N1, the ATVC of the primary transfer portion N1 similar to the above-described ATVC of the secondary transfer portion N2 is carried out in a period from a start of the job until the toner image is fed to the primary transfer portion N1, but detailed description thereof will be omitted in this embodiment. In the following, the ATVC is the ATVC of the secondary transfer portion N2.

### 6. Control of Pre-Charging Bias

In this embodiment, the pre-charging bias is applied by the constant-voltage control. The pre-charging power source E5 incorporates a voltage detecting portion (not shown) as a voltage detecting means, and it is possible to carry out the constant-voltage control of an output voltage so that a value of a voltage detected by this voltage detecting portion becomes substantially constant.

Here, depending on the kind of the recording material, the environment, and further the print surface (surface onto which the toner image is transferred in the secondary transfer portion N2 immediately after passing through the pre-charging portion N3, whether the surface is the first surface (side) in one-side printing or the double-side printing or the second surface (side) in the double-side printing), a target voltage of an appropriate pre-charging bias various in some instances.

For that reason, on the basis of at least one of the kinds of the recording material S, the environment, and the print surface, whether or not the pre-charging bias is applied can be determined, or the target voltage of the pre-charging bias can be changed. For example, the target voltage of the pre-charging bias is preset and may be stored as table data or the like in the memory 122 so that the surface of the recording material S onto which the toner image is transferred has an appropriate charge amount depending on the kind of the recording material S or the environment (for example, absolute water content). The appropriate toner amount of the toner image transfer surface of the recording material S can be acquired as an appropriate toner amount providing an appropriate transfer property in advance by an experiment or the like. Further, for example, only in the case where the recording material S of a predetermined kind is used only in the case where the recording material S of the predetermined kind is used and in addition, the absolute water content falls in a predetermined range (for example, in the case where the absolute water content is smaller than a predetermined value), the pre-charging bias may be applied or the like.

A table 1 below shows an example of a setting of the target voltage of the pre-charging bias.

TABLE 1
AMBIENT WATER CONTENT (g/kg)
0.9 OR LESS

| | | |
|---|---|---|
| | • | |
| | • | |
| SYNTHETIC | PE | −1000 V |
| PAPER | PP | −5500 V |
| | • | |
| | • | |

For simplicity, in this embodiment, when a job is started, depending on the paper kind category information as the recording material information, whether or not the pre-charging bias is applied to the driving roller 84 (propriety of the pre-charging bias) is determined. As an example, in this embodiment, in the case where a paper kind category of the synthetic paper or the high-resistance paper (ultra-thick paper) is selected when the job is started, discrimination that the pre-charging is needed is made. In this embodiment, in the case where a paper kind category other than the synthetic paper or the high-resistance paper (ultra-thick paper) is selected, discrimination that the pre-charging is not needed is made.

In the constitution of this embodiment, for example, in the case where synthetic paper (“YUPO YPI200” (product name), manufactured by YUPO Corp.) is used as the recording material S, for example, in an environment of 0.9 g/kg in absolute water content, the target current is short only by the secondary transfer bias. The YUPO YPI200 is a paper kind category of PP (polypropylene). For that reason, in this case, a pre-charging bias of −5500 V is applied to the driving roller 84. By this, the toner image transfer surface of the recording material S can be charged sufficiently. Further, in the constitution of this embodiment, in the case where synthetic paper (“Laser Peach WETY-210” (product name), manufactured by Daio Paper Corp.) is used as the recording material S, for example, in the environment of 0.9 g/kg in absolute water content, the target current is short only by the secondary transfer bias. The Laser Peach WETY-210 is a paper kind category of PE (polyethylene). For that reason, in this case, a pre-charging bias of −1000 V if applied to the driving roller 84.

However, as described above, in the constitution in which the pre-charging is performed on the secondary transfer belt 80, when the setting of the pre-charging such as turning on/off of the output of the pre-charging is switched, a potential (surface potential or the like) of the secondary transfer belt 80 fluctuates. By this, it becomes difficult to apply an appropriate secondary transfer bias in the secondary transfer portion N2.

Therefore, in this embodiment, in a job in which the pre-charging is performed, the image forming apparatus 100 is constituted so as to carry out the ATVC (acquisition of the electric resistance information of the secondary transfer portion N2) when a region of the secondary transfer belt 80 to which the pre-charging bias is applied passes through the secondary transfer portion N2. When the region of the secondary transfer belt 80 to which the pre-charging bias is applies passes through the secondary transfer portion N2 is when a region of the secondary transfer belt 80, with respect to the rotational direction of the secondary transfer belt 80, to which the pre-charging bias is applied and which passed through the pre-charging portion N3 passes through the secondary transfer portion N2 immediately thereafter (first). In this case, the ATVC may preferably be carried out when the region of the secondary transfer belt 80 to which the pre-charging bias with the same setting as a setting during image formation (secondary transfer) in the job is applied. On the other hand, in this embodiment, in a job in which the pre-charging is not performed, the image forming apparatus 100 is constituted so as to carry out the ATVC when the region of the secondary transfer belt 80 to which the pre-charging bias is not applied through the secondary transfer portion N2. When the region of the secondary transfer belt 80 to which the pre-charging bias is not applied passes through the secondary transfer portion N2 is when a region of the secondary transfer belt 80, with respect to the rotational direction of the secondary transfer belt 80, to which the pre-charging bias is not applied and which passed through the pre-charging portion N3 passes through the secondary transfer portion N2 immediately thereafter (first). Incidentally, the ATVC in the case where the pre-charging is not performed is as described above as a basic operation of the ATVC. A table 2 below is summary of a possibility that an image defect in the secondary transfer portion N2 occurs due to presence/absence of the pre-charging.

TABLE 2

| | (1) | (2) | (3) |
|---|---|---|---|
| PB*¹ | NO | YES | YES |
| ATVC*² | — | NO | YES |
| ID*³ | YES | YES | NO |

^{*1}“PB” is the pre-charging bias.
^{*2}“ATVC” is the ATVC in the secondary transfer portion in a pre-charging bias application state.
^{*3}“ID” is the image defect in the secondary transfer portion.

In the case of (1) in the table 2, the pre-charging is not performed, and therefore, the ATVC is not needed in a state in which the pre-charging bias is applied. Further, by carrying out the ATVC in a state in which the pre-charging bias is not applied, the secondary transfer bias can be appropriately set. On the other hand, in the case of (2) in the table 2, when the pre-charging is performed, the ATVC is performed in the state in which the pre-charging bias is not applied, and therefore, a setting of the secondary transfer bias is not appropriate, so that there is a possibility that the image defect occurs. During the application of the pre-charging bias, when compared with during non-application of the pre-charging bias, the potential of the secondary transfer belt 80 fluctuates, and therefore, an appropriate secondary transfer bias cannot be applied, so that there is a possibility that the image defect occurs in the secondary transfer portion N2. Further, in the case of (3) in the table 2, in accordance with this embodiment, the ATVC is carried out in the state in which the pre-charging bias is applied in the case where the pre-charging is performed, and therefore, the secondary transfer bias can be appropriately set. This is because in the ATVC, a current (or a voltage) depending on the potential of the secondary transfer belt 80 due to the presence/absence of the pre-charging is detected. Accordingly, the ATVC is performed in the state in which the pre-charging is turned on or off depending on the presence/absence of the pre-charging during the image formation (during the secondary transfer) in the job, so that the secondary transfer bias during the image formation (during the secondary transfer) can be appropriately set.

Incidentally, in the case where a cleaning bias is applied to the first and second brush rollers 87 and 88 during the image formation (during the secondary transfer) in the job, the ATVC may preferably be carried out in a state in which the region of the secondary transfer belt 80 to which the cleaning bias is applied passes through the secondary transfer portion N2. When the region of the secondary transfer belt 80 to which the cleaning bias is applied passes through the secondary transfer portion N2 is when the region of the secondary transfer belt 80, with respect to the rotational direction of the secondary transfer belt 80, to which the cleaning bias is applied and which passed through a contact portion between the first and second brush rollers 87 and 88 to which the cleaning bias is applied passes through the secondary transfer portion N2. Also, in this case, the ATVC may preferably be carried out when the region of the secondary transfer belt 80 to which the cleaning bias with the same setting as the setting during the image formation (during the secondary transfer) in the job is applied passes through the secondary transfer portion N2. On the other hand, in the case where the cleaning bias is not applied to the first and second brush rollers 87 and 88 during the image formation (during the secondary transfer) in the job, the ATVC may preferably be carried out in a state in which the region of the secondary transfer belt 80 to which the cleaning bias is not applied passes through the secondary transfer portion N2. When the region of the secondary transfer belt 80 to which the cleaning bias is not applied passes through the secondary transfer portion N2 is when the region of the secondary transfer belt 80, with respect to the rotational direction of the secondary transfer belt 80, passed through the contact portion between the first and second brush rollers 87 and 88 passes through the secondary transfer portion N2 immediately thereafter (first).

### 7. Control Procedure

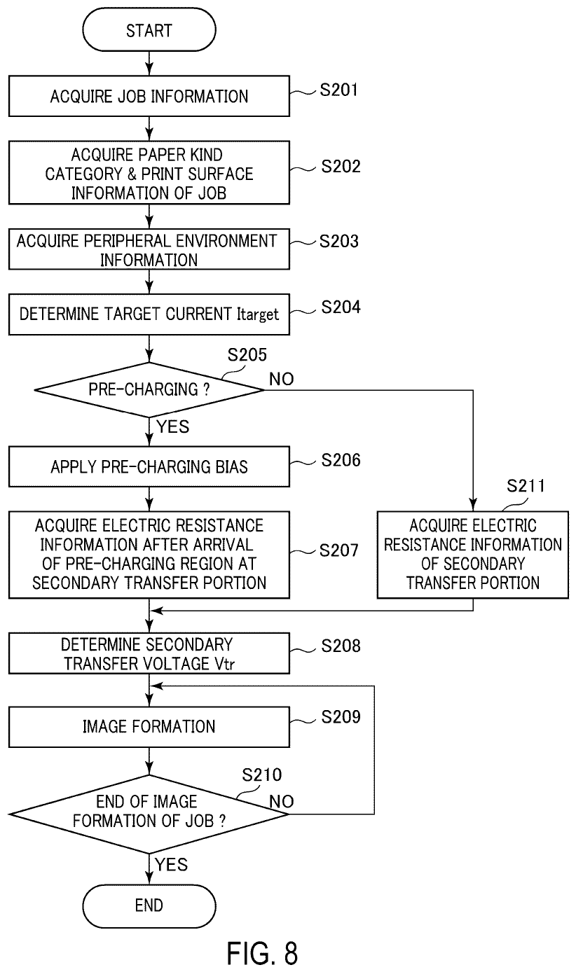

Next, a control procedure of a job including the ATVC in this embodiment will be described. FIG. 8 is a flowchart showing an outline of the control procedure. For simplicity, it is assumed that the recording materials S of the same kind are used in a single job and that the image formation is carried out in an operation in one-side printing mode. Further, as described above, it is assumed that the propriety of the pre-charging is discriminated depending on the paper kind category as the recording material information. Further, an operation of the ATVC itself may be the same as the above-described basic operation of the ATVC, and therefore, description thereof will be appropriately omitted.

First, when the controller 120 acquires information designating the kind of the recording material S or information on the job including image information, which is inputted from the operating portion 130 or the external device 200 such as the personal computer by the user (S201), the controller 120 acquires the paper kind formation (S202). Incidentally, the information designating the kind of the recording material S may be information designating either one of the cassettes 11a and 11b in which the recording materials S are accommodated (the same applies hereinafter). In this case, the controller 120 is capable of discriminating the kind of the recording material S used in the image formation from information showing a preset relationship between the cassette 11a and 11b with the kind of the recording materials S accommodated therein. Further, as described above, for simplicity, the job in the operation in the one-side printing mode is described as an example, but in S201, print surface information can be acquired in addition to the paper kind category information, so that control depending on the print surface can also be carried out as described above (the same applies hereinafter). Further, the controller 120 acquires environment information (S203), and determines the target current Itarget on the basis of the pieces of information acquired in S202 and S203 (S204).

Next, the controller 120 discriminates whether or not the pre-charging is needed, in the job, on the basis of the paper kind category information acquired in S202 (S205). In the case where the controller 120 discriminated in S205 that the pre-charging is needed, the controller 120 causes the pre-charging power source to start application of the pre-charging bias to the driving roller 84 (S206). At this time, on the basis of the table data as shown in the table 1, the controller 120 sets the pre-charging bias equal to the pre-charging bias during the image formation (during the pre-charging) in the job depending on the paper kind category. Then, the controller 120 causes the secondary transfer belt 80 to rotate and carries out the ATVC by test biases of a plurality of levels at a timing, when the region of the secondary transfer belt 80 to which the pre-charging bias is applied reaches the secondary transfer portion N2, and later. By this, the controller 120 acquires electric resistance information (voltage-current characteristic) of the secondary transfer portion N2, and acquires the base voltage Vb (S207). At this time, in this embodiment, the ATVC is carried out in a state in which biases are applied to the inner secondary transfer roller 71 and the first and second brush rollers 87 and 88 and in which a bias is applied to the driving roller 84. Further, the controller 120 determines a voltage value Vtr of the secondary transfer bias during the image formation (during the secondary transfer) from the base voltage Vb acquired in S207 and the recording material part voltage Vp acquired depending on the paper kind category information (S208). Thereafter, the controller 120 causes the image forming portion to form the image in the job by using the determined secondary transfer bias (S209). Then, when formation of all the images in the job is ended (S210), the controller 120 ends the operation in the job.

Further, in the case where the controller 120 discriminated in S205 that the pre-charging is not needed, the controller 120 carries out the ATVC without causing the pre-charging power source to start the application of the pre-charging bias to the driving roller 84 (S211), and causes the processing to go to S208.

Thus, in this embodiment, when the secondary transfer bias for forming the image on the recording material S requiring the pre-charging is set, the ATVC is carried out in the state in which the pre-charging bias is applied.

By this, it is possible to set the secondary transfer bias depending on a potential fluctuation of the secondary transfer belt 80 due to the pre-charging.

As described above, in this embodiment, the image forming apparatus 100 includes the image bearing member (intermediary transfer belt) 70 for bearing the toner image; the rotatable transfer belt (secondary transfer belt) 80 constituted by the endless belt and for forming the transfer portion (secondary transfer portion) N2 in contact with the image bearing member 70, the transfer belt conveying the recording materials toward the transfer portion N2 while carrying the recording material S; the first applying portion (secondary transfer power source) E4 for applying, to the transfer portion N2, the transfer bias for transferring the toner image from the image bearing member 70 onto the recording material S; a first member (driving roller, pre-charging roller) 84 provided on the inner peripheral surface side of the transfer belt 80 and on a side upstream of the transfer portion N2 with respect to the recording material S conveying direction and for forming the charging portion (pre-charging portion) N3 where the transfer surface which is a surface of the recording material S onto which the toner image is transferred and which is conveyed to the transfer portion N2 by the transfer belt 80 is electrically charged to the opposite polarity to the normal charge polarity of toner; a second member (pre-charging opposite roller) 91 provided on the outer peripheral surface side of the transfer belt 80 and for forming the charging portion N3 while sandwiching the transfer belt 80 between itself and the first member 84; a second applying portion (pre-charging power source) E5 for applying, to the charging portion N3, a charging bias for charging the transfer surface of the recording material S to the opposite polarity; the detecting portion (in this embodiment, the current detecting sensor) 25b for detecting a current flowing through the transfer portion N2 or a voltage applied to the transfer portion N2; and the controller 120 for setting the transfer bias on the basis of a detection result by the detecting portion 25b. The controller 120 sets the transfer bias when the toner image is transferred onto the recording material S of which transfer surface is charged to the opposite polarity in the charging portion N3, on the basis of a detection result by the detecting portion 25b when a region of the transfer belt 80 passed through the charging portion N3 when the charging bias is applied to the charging portion N3 passes through the transfer portion N2 immediately thereafter. In this embodiment, the controller 120 sets the transfer bias when the toner image is transferred onto the recording material S of which transfer surface is not charged to the opposite polarity in the charging portion N3, on the basis of a detection result by the detecting portion 25b when a region of the transfer belt passed through the charging portion N3 when the charging bias is not applied to the charging portion N3 passes through the transfer portion N2 immediately thereafter. Further, the second applying portion E5 applies, to the first member, a charging bias of the same polarity as the normal charge polarity of the toner. However, as described later, the second applying portion E5 can also apply, to the second member, the charging bias of the above-described opposite polarity to the normal charge polarity of the toner. Further, in this embodiment, the image bearing member 70 is the intermediary transfer member onto which the toner image is transferred from another image bearing member (photosensitive drum) 1. Further, in this embodiment, on the basis of information on the recording material S, the controller 120 sets whether or not the transfer surface of the recording material S is charged to the above-described opposite polarity in the charging portion N3. Further, in this embodiment, on the basis of the information on the recording material S, the controller 120 changes the charging bias when the recording material is charged to the above-described opposite polarity in the charging portion N3.

Further, according to this embodiment, in the constitution in which the pre-charging is performed on the belt by using the belt-type transfer member, by switching the setting of the pre-charging, it is possible to suppress that it becomes difficult to appropriately set the transfer bias.

### Embodiment 2

Next, another embodiment of the present invention will be described. Basic constitutions and operations of an image forming apparatus in this embodiment are the same as those of the image forming apparatus of the embodiment 1. Accordingly, in the image forming apparatus of this embodiment, elements having the same or corresponding functions or constitutions as those of the image forming apparatus of the embodiment 1 are represented by the same reference numerals or symbols as those in the embodiment 1 and will be omitted from detailed description.

### 1. Outline of This Embodiment

In the embodiment 1, an example of the control procedure in the case where the single job is executed was described, but in this embodiment, an example of a control procedure in the case where a continuous job is executed will be described.

### 2. Control Procedure

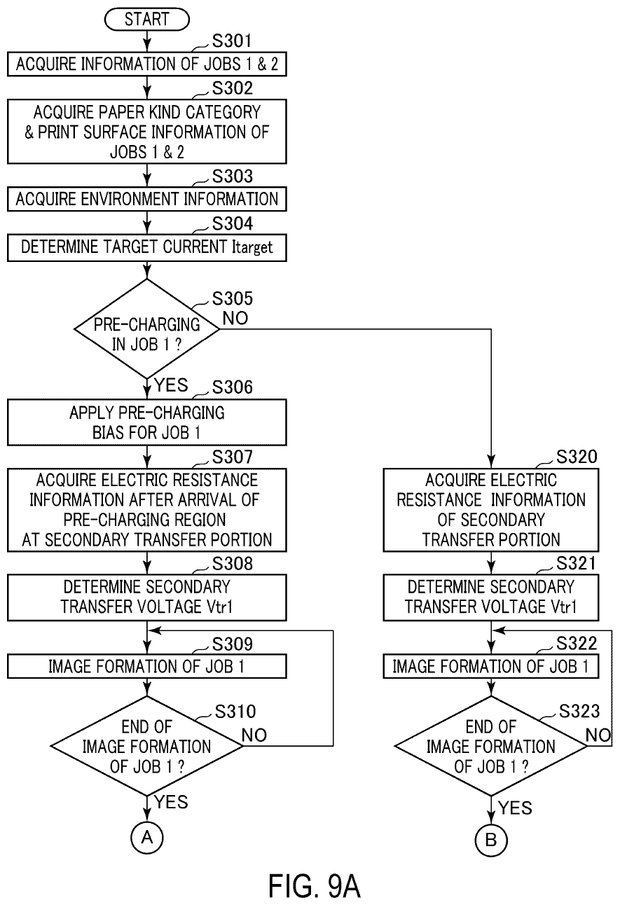

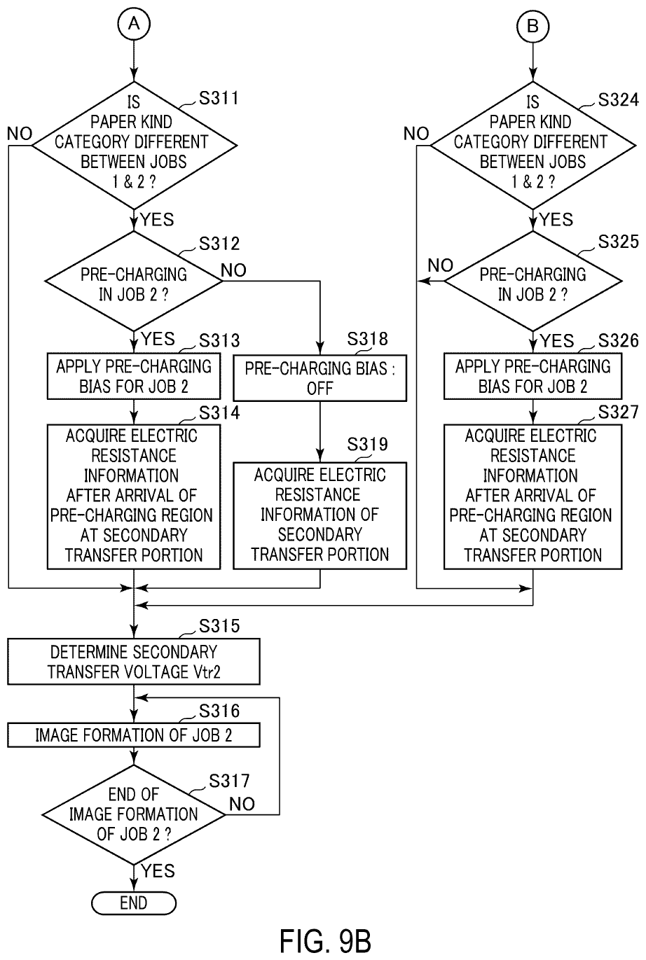

Next, the control procedure of the job including the ATVC in this embodiment will be described. FIG. 9 is a flowchart showing an outline of the control procedure. In this embodiment, a continuous job of two jobs consisting of job 1 and job 2 will be described as an example. The job 1 is a first job, and the job 2 is a second job. For simplicity, it is assumed that the recording materials S of the same kind are used in a single job and that the image formation is carried out in an operation in one-side printing mode. Further, similarly as in the embodiment 1, it is assumed that the propriety of the pre-charging is discriminated depending on the paper kind category as the recording material information. Further, an operation of the ATVC itself may be the same as the above-described basic operation of the ATVC, and therefore, description thereof will be appropriately omitted.

Further, FIG. 9 is divided, for convenience, into FIG. 9A and FIG. 9B, in which procedures of “A” and “B” in these figures are connected to each other, respectively.

First, when the controller 120 acquires information, on the job 1 and the job 2 constituting the continuous job, which is inputted from the operating portion 130 or the external device 200 such as the personal computer by the user (S301), the controller 120 acquires the paper kind formation of each of the job 1 and the job 2 (S302). Further, the controller 120 acquires environment information (S303), and determines the target current Itarget of each of the job 1 and the job 2 on the basis of the pieces of information acquired in S302 and S303 (S304).

Next, the controller 120 discriminates whether or not the pre-charging is needed, in the job 1, on the basis of the paper kind category information acquired in S302 (S305). In the case where the controller 120 discriminated in S305 that the pre-charging is needed in the job 1, the controller 120 causes the pre-charging power source to start application of the pre-charging bias for the job 2 to the driving roller 84 (S306). At this time, on the basis of the table data as shown in the table 1 described in the embodiment 1, the controller 120 sets the pre-charging bias equal to the pre-charging bias during the image formation (during the pre-charging) in the job 1 depending on the paper kind category. Then, the controller 120 causes the secondary transfer belt 80 to rotate and carries out the ATVC by test biases of a plurality of levels at a timing, when the region of the secondary transfer belt 80 to which the pre-charging bias for the job 1 is applied reaches the secondary transfer portion N2, and later. By this, the controller 120 acquires electric resistance information (voltage-current characteristic) of the secondary transfer portion N2, and acquires the base voltage Vb (S307). Further, the controller 120 determines a voltage value Vtr1 of the secondary transfer bias during the image formation (during the secondary transfer) of the job 1 from the base voltage Vb acquired in S307 and the recording material part voltage Vp acquired depending on the paper kind category information in the job 1 (S308). Thereafter, the controller 120 causes the image forming portion to form the image in the job by using the determined secondary transfer bias in the job 1 (S309). Further, when formation of all the images in the job 1 is ended (S310), the controller 120 discriminates whether or not the paper kind category of the job 1 and the paper kind category of the job 2 are different from each other (S311). In the case where the controller 120 discriminated in S311 that the paper kind categories are different from each other, the controller 120 discriminates whether or not the pre-charging is needed in the job 2 (S312). In the case where the controller discriminated in S312 that the pre-charging is needed in the job 2, the controller 120 causes the pre-charging bias power source to start application of the pre-charging bias for the job 2 to the driving roller 84 (S313). At this time, on the basis of the table data as shown in the table 1 described in the embodiment 1, the controller 120 sets the same pre-charging bias to a pre-charging bias during the image formation (during the pre-charging) in the job 2 depending on the paper kind category in the job 2. Then, the controller 120 carries out the ATVC by test biases of a plurality of levels at a timing, when the region of the secondary transfer belt 80 to which the pre-charging bias for the job 2 is applied reaches the secondary transfer portion N2, and later. By this, the controller 120 acquires the electric resistance information (voltage-current characteristic) of the secondary transfer portion N2, and acquires the base voltage Vb (S314). Further, from the base voltage Vb acquired in S314 and the recording material part voltage Vp acquired depending on the paper kind category information of the job 2, the controller 120 determines a voltage value Vtr2 of the secondary transfer bias during the image formation (during the secondary transfer) in the job 2 (S315). Thereafter, the controller 120 carries out the image formation in the job 2 by using the determined secondary transfer bias in the job 2 (S316). Then, when formation of all the images in the job 2 is ended (S317), the controller 120 ends the operation in the job.

Further, in the case where the controller 120 discriminated in S311 that the paper kind categories are not different from each other (i.e., are the same), settings of the pre-charging bias are the same, so that the controller 120 causes the processing to go to S315 without carrying out the ATVC again. Then, the controller 120 determines the voltage value Vtr2 of the secondary transfer bias in the job 2. At this time, the controller 120 determines Vtr2 on the basis of the electric resistance information of the secondary transfer portion N2 acquired in S307 or may be Vtr1, as the Vtr2, determined in S308.

Further, in the case where the controller 120 discriminated in S312 that the pre-charging is not needed in the job 2, the controller 120 causes the pre-charging bias power source to turn off the pre-charging bias (S318). Then, the controller 120 carries out the ATVC by test biases of a plurality of levels at a timing, when the region of the secondary transfer belt 80 when the pre-charging bias is turned off reaches the secondary transfer portion N2, and later. By this, the controller 120 acquires the electric resistance information/voltage-current characteristic of the secondary transfer portion N2, and acquires the base voltage Vb (S319). Subsequently steps are similar to those described above.

Further, in the case where the controller 120 discriminated in S305 that the pre-charging is not needed in the job 1, the controller 120 carries out the ATVC without causing the pre-charging power source to start the application of the pre-charging bias to the driving roller 84 (S320), and determines the voltage value Vtr2 of the secondary transfer bias in the job 1. Thereafter, the controller 120 causes the image forming portion to form the image in the job 1 by using the determined secondary transfer bias for the job 1 (S322). Then, when formation of all the images in the job 1 is ended (S323), the controller 120 discriminates whether or not the paper kind category of the job 1 and the paper kind category of the job 2 are different from each other (S324). In the case where the controller 120 discriminated in S324 that the paper kind categories are different from each other, the controller 120 discriminates whether or not the pre-charging is needed in the job 2 (S325). In the case where the controller 120 discriminated in S325 that the pre-charging is needed in the job 2, the controller 120 causes the pre-charging bias power source to start application of the pre-charging bias for the job 2 to the driving roller 84 (S326). At this time, on the basis of the table data as shown in the table 1 described in the embodiment 1, the controller 120 sets the same pre-charging bias to a pre-charging bias during the image formation (during the pre-charging) in the job 2 depending on the paper kind category in the job 2. Then, the controller 120 carries out the ATVC by test biases of a plurality of levels at a timing, when the region of the secondary transfer belt 80 to which the pre-charging bias for the job 2 is applied reaches the secondary transfer portion N2, and later. By this, the controller 120 acquires the electric resistance information (voltage-current characteristic) of the secondary transfer portion N2, and acquires the base voltage Vb (S327). Thereafter, the controller 120 causes the processing to go to S315.

Further, in the case where the controller 120 discriminated in S324 that the paper kind categories are not different from each other (i.e., are the same) and in the case, the controller 120 discriminated in S325 that the pre-charging is not needed, the pre-charging bias is still turned off, so that the controller 120 causes the processing to go to S315 without carrying out the ATVC again. Then, the controller 120 determines the voltage value Vtr2 of the secondary transfer bias in the job 2. At this time, the controller 120 determines Vtr2 on the basis of the electric resistance information of the secondary transfer portion N2 acquired in S320 or may be Vtr1, as the Vtr2, determined in S321.

Thus, in this embodiment, in the case where a job of paper kind categories different in pre-charging bias setting is continued, the ATVC is carried out in the state in which the pre-charging bias is applied before the image formation in each of the jobs.

By this, it is possible to set the secondary transfer bias depending on a potential fluctuation of the secondary transfer belt 80 due to the pre-charging in each of the jobs.

In the embodiment 2, when the continuous job is executed, the ATVC was carried out every switching of the setting of the pre-charging between the jobs. In this embodiment, in order to suppress a lowering in productivity thereby, in the case where the presence and the absence of the pre-charging is switched, prediction of the electric resistance of the secondary transfer portion N2 is made.

### 2. Control Procedure

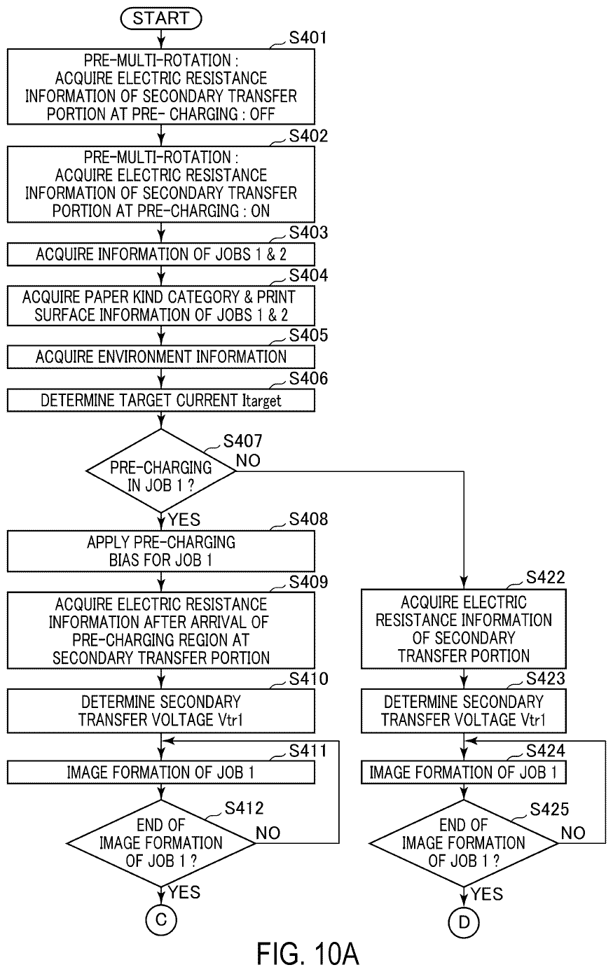

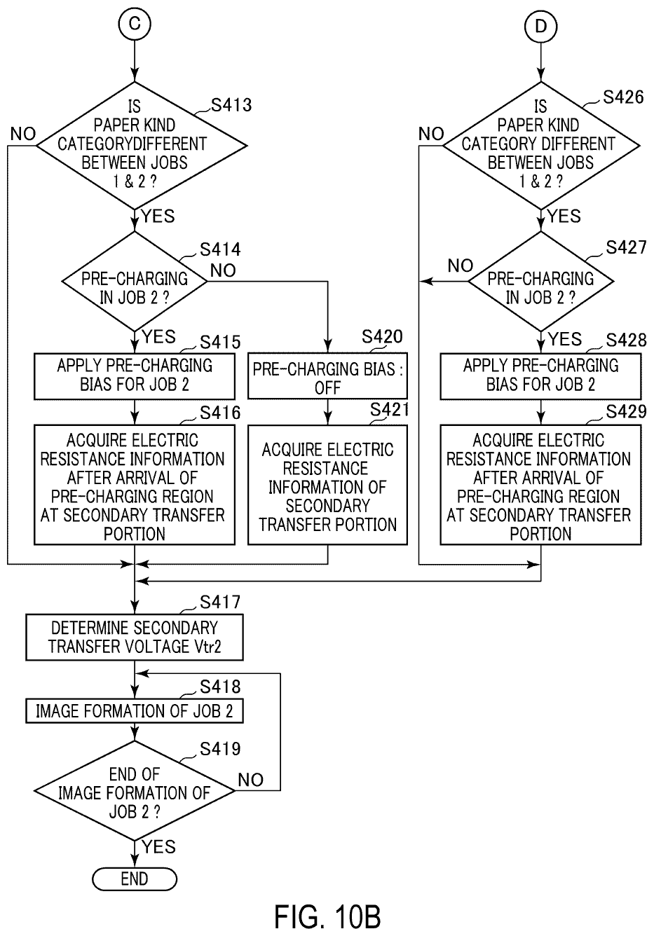

Next, the control procedure of the job including the ATVC in this embodiment will be described. FIG. 10 is a flowchart showing an outline of the control procedure. In this embodiment, a continuous job of two jobs consisting of job 1 and job 2 will be described as an example. The job 1 is a first job, and the job 2 is a second job. For simplicity, it is assumed that the recording materials S of the same kind are used in a single job and that the image formation is carried out in an operation in one-side printing mode. Further, similarly as in the embodiments 1 and 2, it is assumed that the propriety of the pre-charging is discriminated depending on the paper kind category as the recording material information. Further, an operation of the ATVC itself may be the same as the above-described basic operation of the ATVC, and therefore, description thereof will be appropriately omitted.

Further, FIG. 10 is divided, for convenience, into FIG. 10A and FIG. 10B, in which procedures of “C” and “D” in these figures are connected to each other, respectively. Further, in control in this embodiment shown in FIG. 10, processing similar to the processing in the control of the embodiment 2 shown in FIG. 9 will be appropriately omitted from description.

First, before a job is inputted, in a pre-multi-rotation step, the ATVC by test biases of a plurality of levels is carried out in a state in which the pre-charging bias is not applied to the driving roller 84, so that the controller 120 acquires the electric resistance information (voltage-current characteristic) of the secondary transfer portion N2 (S401). The controller 120 causes the memory 122 to store the acquired information. Next, the controller 120 causes the pre-charging bias power source to start application of the pre-charging bias to the driving roller 84, and carries out the ATVC by test biases of a plurality of levels at a timing, when a region of the secondary transfer belt 80 to which the pre-charging bias is applied reaches the secondary transfer portion N2, and later. By this, the controller 120 acquires the electric resistance information (voltage-current characteristic) of the secondary transfer portion N2 (S402). The controller 120 causes the memory 122 to store the acquired information. Here, a value of the pre-charging bias applied in S402 may be a preset representative value. For example, the value of the pre-charging bias may be a value depending on either one of the paper kind categories.

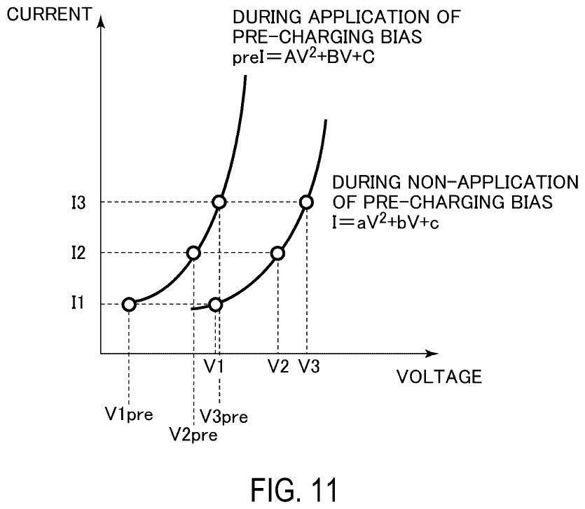

Thereafter, processes S403 to S420 are the same as the processes S301 to S318, respectively, in FIG. 9. The job 1 is a job in which the pre-charging is needed and the job 2 is a job in which the pre-charging is not needed, and therefore, the process S420 is a process in which after the image formation in the job 1 is ended, the pre-charging bias is shifted from ON to OFF. When the pre-charging bias is turned off, the electric resistance of the secondary transfer portion N2 (the potential of the secondary transfer belt 80) changes. However, when the ATVC by the test biases of the plurality of levels is carried out during the continuous job, productivity lowers. Therefore, in this embodiment, on the basis of a difference in electric resistance information, between during application of the pre-charging bias and during non-application of the pre-charging bias, acquired during the pre-multi-rotation step (S401, S402) and stored in the memory 122 (RAM), the controller 120 predicts the electric resistance of the secondary transfer portion N2 during the non-application of the pre-charging bias in the job 2 (S420). That is, on the basis of a difference between the electric resistance information during the pre-charging bias application acquired in S409, in the job 1 and the above-described electric resistance information, electric resistance information during the non-application of the pre-charging bias in the job 2 is predicted. As shown in FIG. 11, the voltage-current characteristic changes between during the application of the pre-charging bias and during the non-application of the pre-charging bias. A difference Δ of a voltage at a target between voltage-current characteristics, during the application of the pre-charging bias and during the non-application of the pre-charging bias, acquired in advance during the pre-multi-rotation is subtracted from the electric resistance information acquired in the job 1 (S409). That is, the difference Δ is subtracted from the voltage at the target current in the voltage-current characteristic acquired in the job 1 (S409). By this, the electric resistance of the secondary transfer portion N2 during the non-application of the pre-charging bias in the job 2 is predicted, so that the base voltage Vb can be acquired. Accordingly, on the basis of the base voltage Vb corresponding to the predicted electric resistance of the secondary transfer portion N2, the voltage value Vtr2 of the secondary transfer bias in the job 2 can be determined (S417), the image formation in the job 2 can be carried out.

Further, processes S422 to S428 are the same as the processes S320 to S326, respectively, in FIG. 9. The job 1 is a job in which the pre-charging is not needed and the job 2 is a job in which the pre-charging is needed, and therefore, the process S428 is a process in which after the image formation in the job 1 is ended, the pre-charging bias is shifted from OFF to ON. Also, in this case, similarly as described above, on the basis of a difference in electric resistance information, between during application of the pre-charging bias and during non-application of the pre-charging bias, acquired during the pre-multi-rotation step (S401, S402) and stored in the memory 122 (RAM), the controller 120 predicts the electric resistance of the secondary transfer portion N2 during the application of the pre-charging bias in the job 2 (S429). That is, on the basis of a difference between the electric resistance information during the non-application of the pre-charging belt, acquired in S422, in the job 1 and the above-described electric resistance information, electric resistance information during the application of the pre-charging bias in the job 2 is predicted. In this case, a difference Δ of a voltage at a target between voltage-current characteristics, during the application of the pre-charging bias and during the non-application of the pre-charging bias, acquired in advance during the pre-multi-rotation is added to the electric resistance information acquired in the job 1 (S422). That is, the difference Δ is added to the voltage at the target current in the voltage-current characteristic acquired in the job 1 (S422). By this, the electric resistance of the secondary transfer portion N2 during the non-application of the pre-charging bias in the job 2 is predicted, so that the base voltage Vb can be acquired. Accordingly, on the basis of the base voltage Vb corresponding to the predicted electric resistance of the secondary transfer portion N2, the voltage value Vtr2 of the secondary transfer bias in the job 2 can be determined (S417), the image formation in the job 2 can be carried out.

Thus, in the case where the presence and the absence of the pre-charging are switched, prediction of the electric resistance of the secondary transfer portion N2 after the switching is made, so that a lowering in productivity due to execution of the ATVC can be suppressed. Further, it is possible to set the secondary transfer bias depending on a potential fluctuation of the secondary transfer belt 80 due to the pre-charging.

Incidentally, in this embodiment, during the pre-multi-rotation, the electric resistance information of the secondary transfer portion N2 between the application of the pre-charging bias and the non-application of the pre-charging bias was acquired, but this information may also be acquired a stand-by time such as temperature control of the fixing portion (fixing device) 15, or during pre-rotation in the job.

Further, in this embodiment, the time of switching between the presence and the absence of the first pre-charging in the continuous job was described, but the prediction of the electric resistance of the secondary transfer portion N2 can also be similarly made in the case where switching between the presence and the absence of the pre-charging is made two times or more in the continuous job. In this case, typically, the prediction can be made on the basis of preliminarily acquired electric resistance information (difference information) of the secondary transfer portion N2 between the application of the pre-charging bias and the non-application of the pre-charging bias and on the basis of the electric resistance information of the secondary transfer portion N2 acquired in the last ATVC. However, the present invention is not limited thereto, but electric resistance information of the secondary transfer portion N2 acquired in the ATVC carried out earlier than the last ATVC may also be used.

Further, in this embodiment, the electric resistance information (difference information) of the secondary transfer portion N2 between the application of the pre-charging bias and the non-application of the pre-charging bias was acquired by using the preset representative value of the pre-charging bias. Also, in this case, the setting of the secondary transfer bias can be made close to an optimum value. However, the present invention is not limited thereto, but the above-described difference information may be acquired by a plurality of settings of the pre-charging biases. Further, during the switching between the presence and the absence of the pre-charging bias, the above-described difference information acquired under the same setting as (or a setting closer than another setting to) a setting of the pre-charging bias during the application of the pre-charging bias after or before the switching can be used.

Further, the control of this embodiment makes the switching between the presence and the absence of the pre-charging depending on the kind or the like of the recording material S, for example, but is also effective that a lowering in productivity is further suppressed in a constitution in which a value of the pre-charging bias is constant. In this case, the processes S413, S416, and S426 are not needed.

Further, in this case, by using the constant value of the pre-charging bias, the electric resistance information (difference information) of the secondary transfer portion N2 between the application of the pre-charging bias and the non-application of the pre-charging bias may only be required to be acquired in advance.

### Embodiment 4

Next, another embodiment of the present invention will be described. Basic constitutions and operations of an image forming apparatus in this embodiment are the same as those of the image forming apparatus of the embodiment 1. Accordingly, in the image forming apparatus of this embodiment, elements having the same or corresponding functions or constitutions as those of the image forming apparatus of the embodiment 1 are represented by the same reference numerals or symbols as those in the embodiment 1 and will be omitted from detailed description.

### 1. Outline of This Embodiment

In the embodiment 3, the prediction of the electric resistance of the secondary transfer portion N2 after the switching between the presence and the absence of the pre-charging was described. In this embodiment, correction control of the secondary transfer bias after this prediction will be described.

### 2. Control Procedure

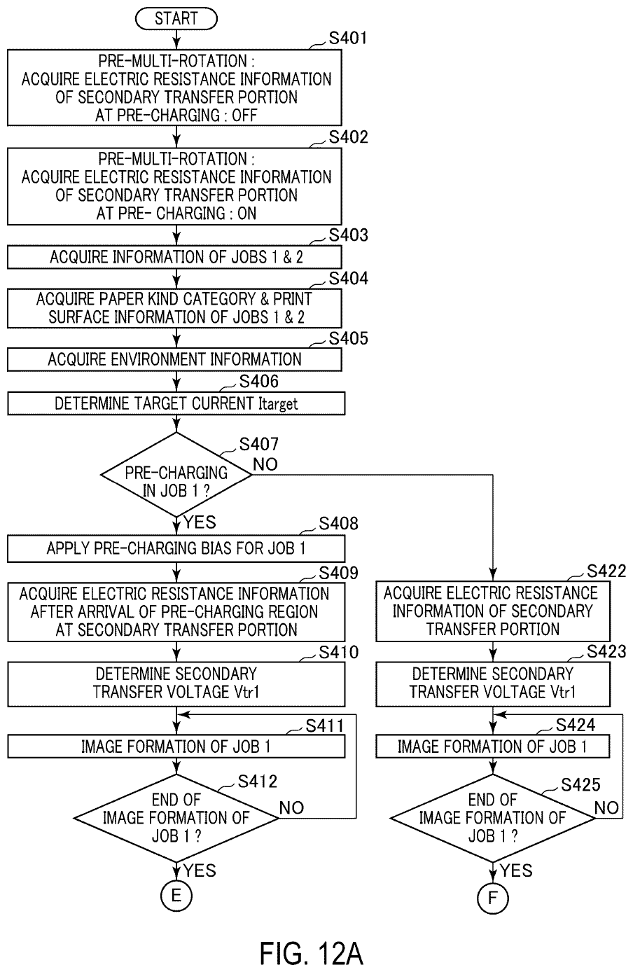

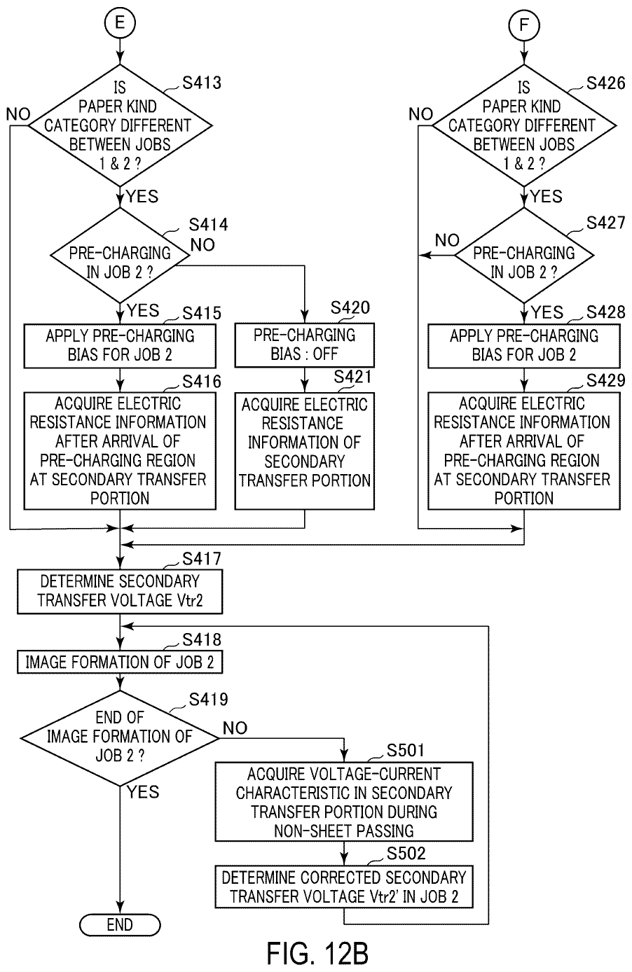

The control procedure of the job including the ATVC in this embodiment will be described. FIG. 12 is a flowchart showing an outline of the control procedure. FIG. 12 is divided, for convenience, into FIG. 12A and FIG. 12B, in which procedures “E” and “F” in these figures are connected to each other, respectively. In the control of this embodiment, some processes are added to the control of the embodiment 3 shown in FIG. 10, but other processes are the same as those in the control of the embodiment 3, and therefore, will be omitted appropriately from description.

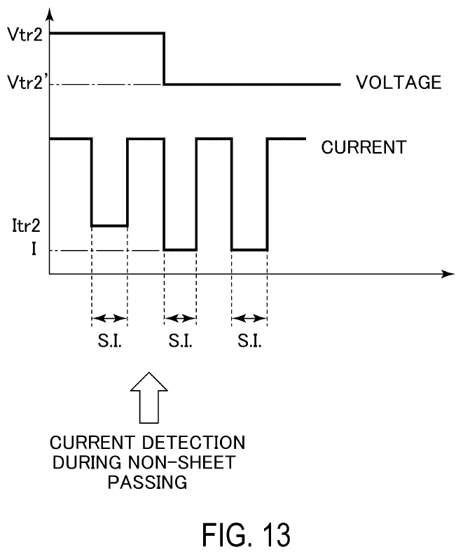

The processing until the determination of the voltage value Vtr2 of the secondary transfer bias in the job 2 (S417) is the same as the processing of the embodiment 3. Further, in this embodiment, in the case where the controller 120 discriminated in S419 that the formation of all the images in the job 2 is not ended, the controller 120 acquires information on the electric resistance of the secondary transfer portion N2 (S501). For example, when the recording material S is absence in the secondary transfer portion N2 (during non-sheet processing), as the information on the electric resistance of the secondary transfer portion N2, a current Itr2 when the voltage Vtr2 is applied is detected by the current detecting sensor 25b. Typically, as shown in FIG. 13, in a sheet interval between a recording material S and a subsequent recording material S, the current Itr2 under application of the voltage Vtr2 is detected by the current detecting sensor 25b. In the case where the detected current Itr2 does not reach a current value I (target current), by using the preliminarily acquired voltage-current characteristic of the secondary transfer portion N2, a correction amount ΔVtr2 is calculated. That is, from a difference between the current Itr2 and a desired current value I (target current), the correction amount ΔVtr2 is calculated by a formula shown below. The preliminarily acquired voltage-current characteristic of the secondary transfer portion N2 is typically a voltage-current characteristic acquired in the ATVC last carried out.

$$Δ Vtr 2 = Δ V / Δ I \times ( Itr 2 - I )$$

Further, the controller 120 determines a voltage value Vtr2′ of the secondary transfer bias after the correction from the calculated values ΔVtr2 and Vtr2 (S502). Then, the controller 120 causes the image forming portion to form the image by using the voltage value Vtr2′ of the secondary transfer bias after the correction (S418).

Incidentally, the voltage value of the secondary transfer bias applied during the non-sheet processing may be not the same as the voltage value Vtr2 of the secondary transfer bias applied immediately therebefore. In this case, the voltage value Vtr2 of the secondary transfer bias may only be required to be corrected so as to correct a fluctuation amount of the electric resistance of the secondary transfer portion N2 on the basis of the acquired current value. Further, as needed, by prolonging the sheet interval, the electric resistance information of the secondary transfer portion N2 may be acquired. Further, the preliminarily acquired voltage-current characteristic of the secondary transfer portion N2 used for the correction may be the voltage-current characteristic of the secondary transfer portion N2 acquired in the ATVC carried out earlier than the ATVC lost carried out.

Thus, in the case where the prediction of the electric resistance of the secondary transfer portion N2 is made, for example, the voltage value of the secondary transfer bias is corrected by acquiring the voltage-current characteristic (in this embodiment, the detection result of the current when a target voltage of the secondary transfer bias is applied) of the secondary transfer portion N2, for example, in the sheet interval. By this, while reducing a time of the ATVC after switching between the presence and the absence of the pre-charging, the voltage value of the secondary transfer bias is corrected to a more appropriate value and thus occurrence of the image defect can be suppressed.

Incidentally, as described above, the control of this embodiment makes the switching between the presence and the absence of the pre-charging depending on the kind or the like of the recording material S, for example, but is also effective that a lowering in productivity is further suppressed in a constitution in which a value of the pre-charging bias is constant. In this case, the processes S413, S416, and S426 are not needed.

Further, in this case, by using the constant value of the pre-charging bias, the electric resistance information (difference information) of the secondary transfer portion N2 between the application of the pre-charging bias and the non-application of the pre-charging bias may only be required to be acquired in advance. Further, in FIG. 12, even in the case where the voltage value Vtr2 is set irrespective of the prediction, the correction of the secondary transfer bias is made. However, the controller 120 discriminates whether or not Vtr2 is set by the prediction and may make the correction of the secondary transfer bias only in the case where Vtr2 is set by the prediction.

Further, in this embodiment, the correction of the voltage value of the secondary transfer bias after the switching between the presence and the absence of the pre-charging in the continuous job was described, but even in the case of a single job in which the pre-charging is performed, the voltage-current characteristic is acquired during the non-sheet processing similarly in the above-described manner, and then the secondary transfer bias may be corrected.

### Other Embodiments

In the above, the present invention was described in accordance with specific embodiments, but is not limited to the above-described embodiments.

In the above-described embodiments, the case where the setting of the pre-charging is changed every job unit, but the present invention is not limited to such an embodiment. For example, there are cases where recording materials different in kind are used in a single job and a setting of the pre-charging is changed. Also, in these cases, a similar effect can be obtained when the control carried out for the job unit in the above-described embodiments is carried out for each recording material unit. That is, by considering the job 1 (n-th job) and the job 2 (n+1)-th job) as a recording material 1 (n-th recording material) and a recording material 2 ((n+1)-th recording material), respectively, the above-described explanation can be applied by analogy.

Further, in the above-described embodiments, to the inner secondary transfer roller 71, the secondary transfer bias of the same polarity as the normal charge polarity of the toner was applied. Further, in the above-described embodiments, of the rollers forming the pre-charging portion N3, to the driving roller 84 disposed on the inner peripheral surface side of the secondary transfer belt 80, the pre-charging bias of the same polarity as the normal charge polarity of the toner was applied. However, the present invention is not limited to such embodiments.

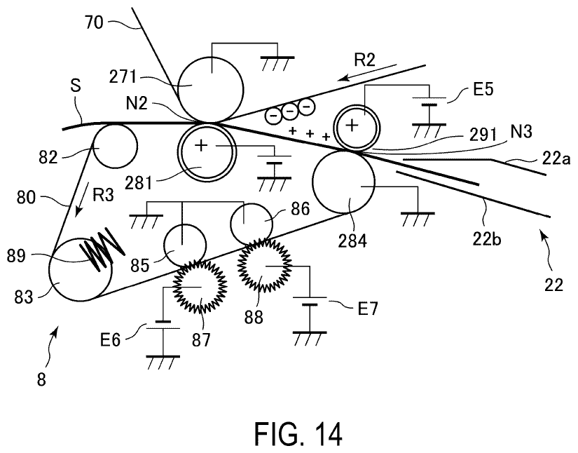

For example, as shown in FIG. 14, to an outer secondary transfer roller 281, a secondary transfer bias of the opposite polarity to the normal charge polarity of the toner may be applied. The outer secondary transfer roller 281 in this case may employ the same constitution as the constitution of the inner secondary transfer roller 71 in the above-described embodiments. That is, as the outer secondary transfer roller 281 in this case, for example, a roller including an ion-conductive foamed rubber (NBR rubber) elastic layer and a core metal and having an outer diameter of 24 mm and a roller surface roughness Rz of 6.0 to 12.0 (μm) can be used. Further, as the outer secondary transfer roller 281 in this case, for example, a roller having a resistance value of 1×10⁵ to 1×10⁷Ω measured under application of a voltage of 2 kV in an environment of N/N (23° C./50% RH) and including an elastic layer of about 30 to 40 in Asker-C hardness can be used. Further, in this case, an inner secondary transfer roller 271 is electrically grounded.

Further, as shown in FIG. 14, of rollers forming the pre-charging portion N3, the roller disposed on an outer peripheral surface side of the secondary transfer belt 80 can be used as a pre-charging roller 291. In this case, to the pre-charging roller 291, a pre-charging bias of the opposite polarity to the normal charge polarity of the toner is applied. By this, the toner image transfer surface of the recording material S can be charged to the opposite polarity to the normal charge polarity of the toner. As this pre-charging roller 291, an elastic sponge roller of an ion-conductive foamed rubber (NBR rubber, ECO rubber) can be used. Further, an outer diameter of this pre-charging roller 291 can be made, for example, 15 mm similarly as the pre-charging opposite roller 91 in the above-described embodiments. Thus, by making the outer diameter of the pre-charging roller 291 relatively small, a distance thereof from the surface of the intermediary transfer belt 70 can be ensured as long as possible. Further, in this case, of the rollers forming the pre-charging portion N3, the roller disposed on an inner peripheral surface side of the secondary transfer belt 80 can be used as a pre-charging opposite roller 284. This pre-charging opposite roller 284 is electrically grounded. Further, this pre-charging opposite roller 284 can be constituted by, for example, a metal roller. In addition, the pre-charging opposite roller 284 can also function as a driving roller for the secondary transfer belt 80. A combination of the rollers for applying biases in the secondary transfer portion N2 and the pre-charging portion N3 can arbitrarily be selected inclusive of those in the above-described embodiments and shown in FIG. 14.

Further, in the above-described embodiments, the pre-charging bias (recording material charging bias) was subjected to the constant-voltage control, but may also be subjected to the constant-current control. The pre-charging bias may only be required to charge the toner image transfer surface of the recording material to the opposite polarity to the normal charge polarity of the toner. In the case where the pre-charging bias is subjected to the constant-current control, instead of the target voltage in the above-described embodiments a target current may only be required to be set.

Further, in the above-described embodiments, the secondary transfer bias was subjected to the constant-voltage control, but may also be subjected to the constant-current control. In the case where the secondary transfer bias is subjected to the constant-current control, for example, in the correction control described in the embodiment 4, a voltage when the target current is supplied during the non-sheet processing may only be required to be detected by the voltage detecting sensor.

Further, in the above-described embodiments, description was made as that the setting of the pre-charging is changed depending on the paper kind category, but as described above, instead thereof or in addition thereto, the setting of the pre-charging may be changed depending on the environment or the print surface.

Further, in the above-described embodiments, the example in which the ATVC is carried out by the test biases of the plurality of levels was described, but the present invention is not limited thereto. The base voltage Vb can be acquired on the basis of a detection result of the current or the voltage when a single or a plurality of values of the test biases (test currents or test voltages) are applied in a state in which the toner image and the recording material S are absence in the secondary transfer portion N2. For example, in the state in which the toner image and the recording material S are absence in the secondary transfer portion N2, to the secondary transfer portion N2, the test biases are applied through the constant-current control so that the current detected by the current detecting sensor 25b becomes the target current corresponding to a predetermined transfer current. Then, a voltage generated at that time is detected by the voltage detecting sensor 25a, and on the basis of a detection result thereof, the base voltage Vb can be acquired. Or, as in the above-described embodiments, in the state in which the toner image and the recording material S are absence in the secondary transfer portion N2, the plurality of test biases are applied to the secondary transfer portion N2 through the constant-current control or the constant-voltage control. Further, on the basis of a detection result of the voltage generated at that time or the current flowing at that time by the voltage detecting sensor 25a or the current detecting sensor 25b, respectively, the voltage-current characteristic (rectilinear line or curved line) is acquired. Then, on the basis of the voltage-current characteristic, the base voltage Vb at which a predetermined transfer current is obtained can be acquired.

Further, in the above-described embodiments, each of the recording material charging member (pre-charging member) and the opposite member (pre-charging opposite member) is the roller-shaped member, but the present invention is not limited thereto, and may also be a roller-shaped member, a brush-shaped member, a sheet-shaped member, a pad-shaped member, or the like independently of each other. As the first member or the second member, the member disposed on the inner peripheral surface side of the transfer member may be a member which does not function as the stretching roller for the transfer belt, and the surface of the transfer belt stretched between the stretching rollers may be sandwiched by the first member and the second member.

Further, in the above-described embodiments, the image forming apparatus was the tandem image forming apparatus employing the intermediary transfer type capable of forming the full-color image. However, the image forming apparatus is not limited to the tandem image forming apparatus. The image forming apparatus may, for example, have a constitution (single drum type) in which toner images are successively transferred from a single first image bearing member onto a second image bearing member (intermediary transfer member) and then the toner images are transferred from the second image bearing member onto the recording material. Further, the image forming apparatus is not limited to the image forming apparatus capable of forming the full-color image, but may also be an image forming apparatus capable of forming only a monochromatic (white/black, monocolor) image. In this case, for example, the present invention is applied to a constitution in which is a transfer belt forming a transfer portion in contact with the image bearing member (photosensitive drum or the like) and the recording material on this transfer belt is pre-charged. Further, the image forming apparatus may be image forming apparatuses for various purposes, such as printers, various printing machines, copying machines, facsimile machines, and multi-function machines.

According to the present invention, in the constitution in which the transfer member of the belt type is used and the pre-charging is performed on the belt, by switching of the setting of the pre-charging, it is possible to suppress that it becomes hard to appropriately set the transfer bias.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-068719 filed on Apr. 19, 2024, which is hereby incorporated by reference herein in its entirety.

What is claimed is:

1. An image forming apparatus comprising:
an image bearing member configured to bear a toner image;
an intermediary transfer member onto which the toner image borne on the image bearing member is transferred;
a rotatable transfer belt constituted by an endless belt and configured to form a transfer portion in contact with the intermediary transfer member, the transfer belt conveying a recording material toward the transfer portion while carrying the recording material;
a first applying portion configured to apply, to the transfer portion, a transfer bias for transferring the toner image from the intermediary transfer member onto the recording material;
a first member provided on an inner peripheral surface side of the transfer belt and on a side upstream of the transfer portion with respect to a recording material conveying direction and configured to form a charging portion where a transfer surface which is a surface of the recording material onto which the toner image is transferred and which is conveyed to the transfer portion by the transfer belt is electrically charged to an opposite polarity to a normal charge polarity of toner;
a second member provided on an outer peripheral surface side of the transfer belt and configured to form the charging portion while sandwiching the transfer belt between itself and the first member;
a second applying portion configured to apply, to the charging portion, a charging bias for charging the transfer surface of the recording material to the opposite polarity;
a detecting portion configured to detect a current flowing through the transfer portion or a voltage applied to the transfer portion; and
a controller configured to set the transfer bias on the basis of a detection result by the detecting portion,
wherein the controller sets the transfer bias when the toner image is transferred onto the recording material of which transfer surface is charged to the opposite polarity in the charging portion, on the basis of a detection result by the detecting portion when a region of the transfer belt passed through the charging portion when the charging bias is applied to the charging portion passes through the transfer portion immediately thereafter.

2. An image forming apparatus according to claim 1, further comprising a storing portion configured to store a first detection result by the detecting portion when the region of the transfer belt passed through the charging portion when the charging bias is applied to the charging portion passes through the transfer portion immediately thereafter and a second detection result by the detecting portion when the region of the transfer belt passed through the charging portion when the charging bias is not applied to the charging portion passes through the transfer portion immediately thereafter, and
wherein the controller sets the transfer bias when the toner image is transferred onto the recording material of which transfer surface is charged to the opposite polarity in the charging portion, on the basis of the first detection result, the second detection result, and a third detection result by the detecting portion when after the first detection result and the second detection result are stored in the storing portion, the region of the transfer belt passed through the charging portion when the charging bias is not applied to the charging portion passes through the transfer portion immediately thereafter.

3. An image forming apparatus according to claim 2, wherein in a case where toner images are transferred onto a first recording material and a second recording material of which transfer surfaces are charged to the opposite polarity in the charging portion,
the controller sets a first transfer bias when the toner image is transferred onto the first recording material, on the basis of the first detection result, the second detection result, and the third detection result, and
the controller sets a second transfer bias when the toner image is transferred onto the second recording material, on the basis of the first transfer bias and a detection result by the detecting portion after the first recording material passes through the transfer portion and before the second recording material reaches the transfer portion.

4. An image forming apparatus according to claim 1, wherein the controller sets the transfer bias when the toner image is transferred onto the recording material of which transfer surface is not charged to the opposite polarity in the charging portion, on the basis of a detection result by the detecting portion when a region of the transfer belt passed through the charging portion when the charging bias is not applied to the charging portion passes through the transfer portion immediately thereafter.

5. An image forming apparatus according to claim 4, further comprising a storing portion configured to store a first detection result by the detecting portion when the region of the transfer belt passed through the charging portion when the charging bias is applied to the charging portion passes through the transfer portion immediately thereafter and a second detection result by the detecting portion when the region of the transfer belt passed through the charging portion when the charging bias is not applied to the charging portion passes through the transfer portion immediately thereafter, and
wherein the controller sets the transfer bias when the toner image is transferred onto the recording material of which transfer surface is not charged to the opposite polarity in the charging portion, on the basis of the first detection result, the second detection result, and a third detection result by the detecting portion when after the first detection result and the second detection result are stored in the storing portion, the region of the transfer belt passed through the charging portion when the charging bias is applied to the charging portion passes through the transfer portion immediately thereafter.

6. An image forming apparatus according to claim 5, wherein in a case where toner images are transferred onto a first recording material and a second recording material of which transfer surfaces are not charged to the opposite polarity in the charging portion,
the controller sets a first transfer bias when the toner image is transferred onto the first recording material, on the basis of the first detection result, the second detection result, and the third detection result, and
the controller sets a second transfer bias when the toner image is transferred onto the second recording material, on the basis of the first transfer bias and a detection result by the detecting portion after the first recording material passes through the transfer portion and before the second recording material reaches the transfer portion.

7. An image forming apparatus according to claim 1, wherein the second applying portion applies, to the first member, a charging bias of the same polarity as the normal charge polarity of the toner.

8. An image forming apparatus according to claim 1, wherein the second applying portion applies, to the second member, the charging bias of the opposite polarity to the normal charge polarity of the toner.

9. An image forming apparatus according to claim 1, wherein on the basis of information on the recording material, the controller sets whether or not the transfer surface of the recording material is charged to the opposite polarity in the charging portion.

10. An image forming apparatus according to claim 1, wherein on the basis of information on the recording material, the controller changes the charging bias when the recording material is charged to the opposite polarity in the charging portion.

11. An image forming apparatus comprising:
an image bearing member configured to bear a toner image;
an intermediary transfer member onto which the toner image borne on the image bearing member is transferred;
a rotatable transfer belt constituted by an endless belt and configured to form a transfer portion in contact with the intermediary transfer member, the transfer belt conveying a recording material toward the transfer portion while carrying the recording material;
a first applying portion configured to apply, to the transfer portion, a transfer bias for transferring the toner image from the intermediary transfer member onto the recording material;
a first member provided on an inner peripheral surface side of the transfer belt and on a side upstream of the transfer portion with respect to a recording material conveying direction and configured to form a charging portion where a transfer surface which is a surface of the recording material onto which the toner image is transferred and which is conveyed to the transfer portion by the transfer belt is electrically charged to an opposite polarity to a normal charge polarity of toner;
a second member provided on an outer peripheral surface side of the transfer belt and configured to form the charging portion while sandwiching the transfer belt between itself and the first member;
a second applying portion configured to apply, to the charging portion, a charging bias for charging the transfer surface of the recording material to the opposite polarity;
a detecting portion configured to detect a current flowing through the transfer portion or a voltage applied to the transfer portion; and
a controller configured to set the transfer bias on the basis of a detection result by the detecting portion,
wherein on the basis of information on the recording material, the controller sets whether or not the transfer surface of the recording material is charged to the opposite polarity in the charging portion.
